(19) United States
(12) Patent Application Publication
(10) Pub. No.: US 2026/0077583 A1
(43) Pub. Date: Mar. 19, 2026

(54) EJECTION STATE DETERMINATION METHOD AND LIQUID EJECTING APPARATUS

(71) Applicant: SEIKO EPSON CORPORATION, Tokyo (JP)

(72) Inventors: Asami OKAMOTO, Matsumoto (JP); Naoki YAMAZAKI, Shiojiri (JP); Akira MIYAGISHI, Shiojiri (JP)

(21) Appl. No.: 19/325,567

(22) Filed: Sep. 11, 2025

(30) Foreign Application Priority Data
Sep. 13, 2024 (JP) 2024-159345

(51) Int. Cl. B41J 2/045

(52) U.S. Cl. CPC B41J 2/0451; B41J 2/04541; B41J 2/0455; B41J 2/0457; B41J 2/04573; B41J 2/04581; B41J 2/04588

(57) ABSTRACT

An ejection state determination method includes a time counting step of acquiring an elapsed time from a time when the previous pre-charging step is executed, a charging time determination step of determining a charging time for storing a charge in a capacitive component of a residual vibration detection circuit according to the elapsed time, a charging step of storing the charge in the capacitive component of the residual vibration detection circuit according to the charging time, a determination driving step of supplying a drive waveform signal as a drive signal to a driving element, a residual vibration acquisition step of acquiring a residual vibration detection signal output by the residual vibration detection circuit after the determination driving step, and an ejecting section determination step of determining a state of an ejecting section based on the residual vibration detection signal acquired in the residual vibration acquisition step.

The present application is based on, and claims priority from JP Application Serial Number 2024-159345, filed Sep. 13, 2024, the disclosure of which is hereby incorporated by reference herein in its entirety.

### BACKGROUND

### 1. Technical Field

The present disclosure relates to an ejection state determination method and a liquid ejecting apparatus.

### 2. Related Art

In a liquid ejecting apparatus that ejects a liquid in response to a pressure change in a pressure chamber, a technique for determining a state of an ejecting section based on residual vibration generated after a pressure in the pressure chamber is changed is known.

For example, JP-A-2022-098988 discloses a technique for improving detection accuracy of residual vibration by charging a capacitive component generated in a wiring through which a signal according to the residual vibration propagates before detecting the residual vibration.

Meanwhile, from the viewpoint of improving a detection speed of the residual vibration, the technique described in JP-A-2022-098988 is not sufficient, and there is room for improvement.

### SUMMARY

According to an aspect of the present disclosure, there is provided an ejection state determination method by a liquid ejecting apparatus including a plurality of ejecting sections that eject a liquid by supplying of a drive signal, a residual vibration detection circuit that acquires any residual vibration signal, which is output by each of the plurality of ejecting sections, according to residual vibration generated after a driving element is driven and outputs a residual vibration detection signal according to the acquired residual vibration signal, and a determination circuit that determines a state of the ejecting section according to the residual vibration detection signal, the method including: a pre-charging step of storing a charge in a capacitive component of the residual vibration detection circuit; and an ejection state determination step of determining the state of the ejecting section based on the residual vibration detection signal, in which the pre-charging step and the ejection state determination step are repeatedly executed, the pre-charging step includes a time counting step of acquiring an elapsed time from a time when the previous pre-charging step is executed, a charging time determination step of determining a charging time for storing the charge in the capacitive component of the residual vibration detection circuit according to the elapsed time, and a charging step of storing the charge in the capacitive component of the residual vibration detection circuit according to the charging time, and the ejection state determination step includes a determination driving step of supplying a drive waveform signal as the drive signal to the driving element, a residual vibration acquisition step of acquiring the residual vibration detection signal output by the residual vibration detection circuit after the determination driving step, and an ejecting section determination step of determining the state of the ejecting section based on the residual vibration detection signal acquired in the residual vibration acquisition step.

According to another aspect of the present disclosure, there is provided a liquid ejecting apparatus including: a plurality of ejecting sections that eject a liquid by supplying of a drive signal; a residual vibration detection circuit that acquires any residual vibration signal, which is output by each of the plurality of ejecting sections, according to residual vibration generated after a driving element is driven and outputs a residual vibration detection signal according to the acquired residual vibration signal; and a determination circuit that determines a state of the ejecting section according to the residual vibration detection signal, in which before the determination circuit determines the state of the ejecting section, a charging time for storing a charge in a capacitive component of the residual vibration detection circuit is determined according to an elapsed time from a time when the charge is previously stored in the capacitive component of the residual vibration detection circuit.

### BRIEF DESCRIPTION OF THE DRAWINGS

FIG. 1 is a diagram illustrating an example of a functional configuration of a liquid ejecting apparatus.

FIG. 2 is a diagram illustrating an example of a schematic internal structure of the liquid ejecting apparatus.

FIG. 3 is a diagram illustrating a schematic structure of an ejecting section.

FIG. 4 is a diagram illustrating an example of arrangement of nozzles.

FIG. 5 is a diagram illustrating an example of a functional configuration of a head unit.

FIG. 6 is a diagram describing an example of various signals input to a coupling state designation circuit.

FIG. 7 is a diagram illustrating an example of a configuration of a waveform shaping circuit.

FIG. 8 is a diagram describing an example of various signals supplied to the head unit during a period in which an ejection process is being executed.

FIG. 9 is a diagram illustrating an example of a relationship between an individual designation signal and a coupling state designation signal in the period in which the ejection process is being executed.

FIG. 10 is a diagram describing an example of various signals input to a supply circuit of the head unit during a period in which a state determination process is being executed.

FIG. 11 is a diagram illustrating an example of a relationship between the individual designation signal and the coupling state designation signal in a period in which a determination process is being executed.

FIG. 12 is a diagram illustrating an example of a relationship between the individual designation signal and the coupling state designation signal in the period in which the determination process is being executed.

FIG. 13 is a diagram describing an example of an acquisition operation of a detection potential signal based on a signal according to residual vibration generated in an ejecting section which is an inspection target.

FIG. 14 is a diagram illustrating an example of a relationship between the individual designation signal and the coupling state designation signal in a period in which a determination preparation process is being executed.

FIG. 15 is a diagram describing an example of various signals input to the supply circuit of the head unit during a period in which a correction value acquisition process is being executed.

FIG. 16 is a diagram describing an example of an operation of the liquid ejecting apparatus during a period in which an acquisition process is being executed.

FIG. 17 is a diagram illustrating an example of a correction value acquisition method.

FIG. 18 is a diagram illustrating an example of an ejection determination method.

FIG. 19 is a diagram illustrating an example of a printing step.

FIG. 20 is a diagram illustrating an example of a state determination step.

### DESCRIPTION OF EMBODIMENTS

Hereinafter, appropriate embodiments of the present disclosure will be described with reference to the drawings. The drawings to be used are for convenience of description. In addition, embodiments to be described below do not inappropriately limit the contents of the present disclosure described in the claims. Moreover, not all of configurations to be described below are necessarily essential components of the present disclosure.

### 1. OVERVIEW OF LIQUID EJECTING APPARATUS

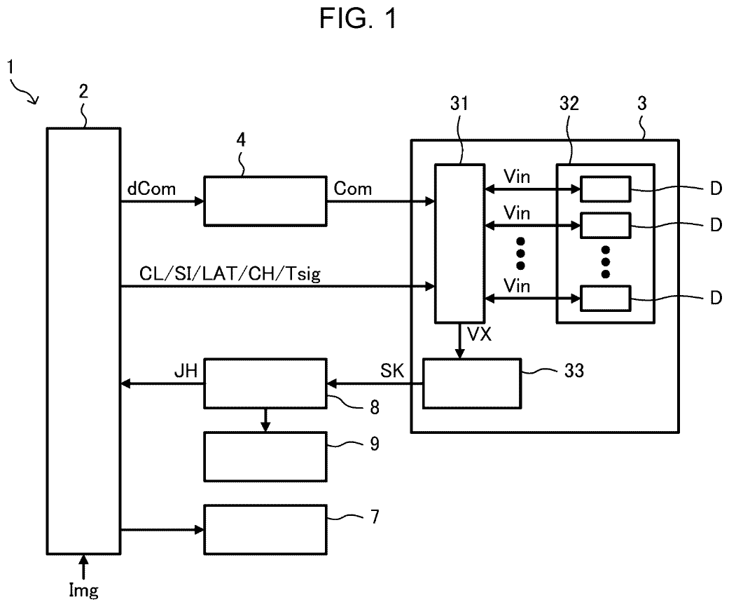

In the present embodiment, a liquid ejecting apparatus 1 will be described as an example of an ink jet printer that ejects inks as an example of a liquid onto a medium such as recording paper to form an image on the medium. FIG. 1 is a diagram illustrating an example of a functional configuration of the liquid ejecting apparatus 1. Image data Img indicating an image to be formed on the medium by the liquid ejecting apparatus 1 is input to the liquid ejecting apparatus 1 from an external device such as a personal computer coupled to an outside. The liquid ejecting apparatus 1 executes a printing process of forming an image indicated by the input image data Img on the medium.

As illustrated in FIG. 1, the liquid ejecting apparatus 1 includes a control unit 2 that controls each section of the liquid ejecting apparatus 1, a head unit 3 that includes a plurality of ejecting sections D that eject inks to a medium, a drive signal output unit 4 that outputs a drive signal Com for driving the plurality of ejecting sections D, a transport unit 7 for changing a relative position of the medium with respect to the head unit 3, a determination unit 8 that determines an ejection state of the inks in the plurality of ejecting sections D, and a storage unit 9 in which a determination condition, a correction value, and the like by the determination unit 8 are stored. In the present embodiment, it is assumed that the liquid ejecting apparatus 1 includes one or a plurality of head units 3, one or a plurality of drive signal output units 4 corresponding to one or a plurality of head units 3 on a one-to-one basis, and one or a plurality of determination units 8 corresponding to one or a plurality of head units 3 on a one-to-one basis. Meanwhile, in the following, for convenience of description, as illustrated in FIG. 1, one head unit 3 among one or the plurality of head units 3, one drive signal output unit 4 provided corresponding to the one head unit 3, and one determination unit 8 provided corresponding to the one head unit 3 will be described.

The control unit 2 is configured with one or a plurality of central processing units (CPU). The control unit 2 may include a programmable logic device such as a field programmable gate array (FPGA) instead of the CPU or in addition to the CPU. The control unit 2 generates and outputs a signal for controlling an operation of each section of the liquid ejecting apparatus 1, such as a clock signal CL, a print data signal SI, a latch signal LAT, a change signal CH, a period designation signal Tsig, and a drive waveform designation signal dCom.

Further, the control unit 2 outputs a control signal for controlling the transport unit 7. Therefore, the transport unit 7 changes a relative position of a medium with respect to the head unit 3.

The drive waveform designation signal dCom output by the control unit 2 is input to the drive signal output unit 4. The drive waveform designation signal dCom is a digital signal that defines a signal waveform of the drive signal Com to be output by the drive signal output unit 4, and the drive signal Com is an analog signal for driving the ejecting section D described below. The drive signal output unit 4 includes a DA conversion circuit. The drive waveform designation signal dCom input to the drive signal output unit 4 is converted into an analog signal by the DA conversion circuit. The drive signal output unit 4 generates the drive signal Com in which a signal waveform defined by the drive waveform designation signal dCom is amplified by performing class D amplification on the analog signal converted by the DA conversion circuit, and outputs the drive signal Com to the head unit 3. Here, the drive signal output unit 4 may generate the drive signal Com in which the signal waveform defined by the drive waveform designation signal dCom is amplified by class B amplification or class AB amplification instead of class D amplification, and output the drive signal Com to the head unit 3.

The clock signal CL, the print data signal SI, the latch signal LAT, the change signal CH, and the period designation signal Tsig output by the control unit 2 are input to the head unit 3. The print data signal SI is a signal that is propagated in synchronization with the clock signal CL, and is a digital signal that designates a type of an operation of the plurality of ejecting sections D in each period defined by the latch signal LAT, the change signal CH, and the period designation signal Tsig. Specifically, the print data signal SI is a signal that designates whether or not to supply the drive signal Com to each of the plurality of ejecting sections D in each period defined by the latch signal LAT, the change signal CH, and the period designation signal Tsig, and thus an operation of the corresponding ejecting section D is designated.

The head unit 3 includes a supply circuit 31, a recording head 32, and a detection circuit 33. Further, the recording head 32 has M ejecting sections D as the plurality of ejecting sections D. In the following description, when any m-th ejecting section D among the M ejecting sections D included in the recording head 32 is designated and described, the m-th ejecting section D may be referred to as an ejecting section D[m]. That is, the recording head 32 has the ejecting sections D[1] to D[M] as the M ejecting sections D. Here, M is a natural number satisfying “M≥1”, and m is a natural number satisfying “1≤m≤M”. Further, in the following description, when a component, a signal, or the like of the liquid ejecting apparatus 1 correspond to the ejecting section D[m] among the M ejecting sections D, the component, the signal, or the like may be given a subscript [m] in reference numeral.

The clock signal CL, the print data signal SI, the latch signal LAT, the change signal CH, the period designation signal Tsig, and the drive signal Com are input to the supply circuit 31 of the head unit 3. The supply circuit 31 switches whether or not to supply the drive signal Com as a supply drive signal Vin to the corresponding ejecting section D based on the print data signal SI at each time defined by the latch signal LAT, the change signal CH, and the period designation signal Tsig. A piezoelectric element PZ to be described below is driven by the supply drive signal Vin being supplied to the piezoelectric element PZ included in the ejecting section D. An amount of ink corresponding to the drive amount of the piezoelectric element PZ is ejected from the ejecting section D.

In addition, the supply circuit 31 switches whether or not to supply a signal according to residual vibration generated in the ejecting section D to the detection circuit 33 as a detection potential signal VX based on the print data signal SI at each time defined by the latch signal LAT, the change signal CH, and the period designation signal Tsig.

The detection circuit 33 generates a detection signal SK based on the detection potential signal VX supplied via the supply circuit 31, and outputs the detection signal SK to the head unit 3. Specifically, the detection circuit 33 amplifies the input detection potential signal VX, removes a noise component, and then converts the signal into a digital signal to generate the detection signal SK and output the detection signal SK from the head unit 3.

The detection signal SK output from the head unit 3 is input to the determination unit 8. The determination unit 8 determines whether or not an ejection state of inks in the ejecting section D is normal, that is, whether or not the ejecting section D is in a normal ejection state in which no ejection abnormality occurs, based on the input detection signal SK. Specifically, the determination unit 8 reads predetermined determination threshold value information and correction value information stored in the storage unit 9 including a non-volatile memory such as a read only memory (ROM), a flash memory, or the like. Here, the determination threshold value information is a threshold value for determining whether or not the ejecting section D is in the normal ejection state in which no ejection abnormality occurs, and the correction value information is information on a correction value for correcting the detection signal SK. The determination unit 8 corrects the input detection signal SK in accordance with the read correction value information, and compares the corrected signal with the determination threshold value information read from the storage unit 9 to determine whether or not the ejection abnormality occurs in the ejecting section D, that is, whether or not the ejecting section D is in the normal ejection state. The determination unit 8 generates ejection state determination information JH indicating a determination result and outputs the ejection state determination information JH to the control unit 2. Here, in the following description, the determination of whether or not the ejection abnormality occurs in the ejecting section D, that is, the determination of whether or not the ejecting section D is in the normal ejection state may be simply referred to as a determination of a state of the ejecting section D.

Here, the ejection abnormality is a general term for a state in which the ejection state of the ink in the ejecting section D is abnormal, which is a state in which the ink cannot be accurately ejected from the ejecting section D. Such an ejection abnormality includes, for example, a state in which the ink cannot be ejected from the ejecting section D, a state in which the ejecting section D ejects the amount of ink different from the ejection amount of ink defined by the drive signal Com, a state in which the ejecting section D ejects the ink at a speed different from an ejection speed of the ink defined by the drive signal Com, and the like.

As described above, when a printing process is being executed, the control unit 2 generates a signal for controlling the head unit 3, such as the print data signal SI, based on the image data Img, and outputs the signal to the head unit 3, and generates a signal for controlling the drive signal output unit 4, such as the drive waveform designation signal dCom, and outputs the signal to the drive signal output unit 4. At this time, the control unit 2 generates and outputs a signal for controlling the transport unit 7. Therefore, the control unit 2 controls the transport unit 7 to change a relative position of a medium with respect to the head unit 3, and adjusts whether or not the ink is ejected from the ejecting section D, the ejection amount of ink, an ink ejection time, and the like. Therefore, an image corresponding to the image data Img is formed on the medium.

Further, the control unit 2 generates a signal for controlling the head unit 3, such as the print data signal SI, which is used to determine the state of the ejecting section D when the printing process is being executed, and outputs the signal to the head unit 3, and generates a signal for controlling the drive signal output unit 4, such as the drive waveform designation signal dCom, and outputs the signal to the drive signal output unit 4. Therefore, the detection circuit 33 outputs the detection signal SK based on the detection potential signal VX supplied via the supply circuit 31 to the determination unit 8, and the determination unit 8 determines whether or not the ink ejection state of the ejecting section D is normal based on the input detection signal SK, and whether the ejecting section D is in the normal ejection state in which no ejection abnormality occurs. The determination unit 8 outputs the ejection state determination information JH according to the determination result of the state of the ejecting section D to the control unit 2. Therefore, the control unit 2 can correct the signal to be output according to the state of the ejecting section D, and a quality of the image formed on the medium is improved.

As described above, in the liquid ejecting apparatus 1 of the present embodiment, the printing process of forming an image according to the image data Img includes the ejection process of ejecting the ink to the medium and the state determination process of determining the state of the ejecting section D that ejects the ink to the medium.

In the liquid ejecting apparatus 1, the control unit 2, the determination unit 8, and the storage unit 9 may be common circuits, and may be configured to be mounted on a common semiconductor device. In addition, at this time, a part or all of the drive signal output unit 4 and the transport unit 7 may be included in the semiconductor device.

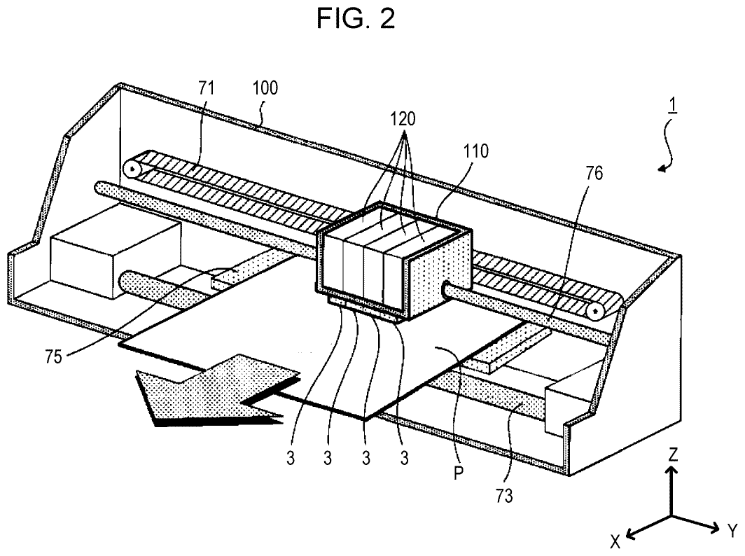

Next, a schematic structure of the liquid ejecting apparatus 1 will be described. FIG. 2 is a diagram illustrating an example of a schematic internal structure of the liquid ejecting apparatus 1. As illustrated in FIG. 2, the liquid ejecting apparatus 1 of the present embodiment is assumed as a serial type ink jet printer. Specifically, when executing a printing process, the liquid ejecting apparatus 1 ejects inks from the M ejecting sections D of the head unit 3 while transporting a medium P such as recording paper in a sub-scanning direction and reciprocating a carriage 110 on which the head unit 3 is mounted in a main scanning direction intersecting the sub-scanning direction, to form dots corresponding to the image data Img on the medium P. The liquid ejecting apparatus 1 is not limited to the serial type ink jet printer, and may be a line type ink jet printer. In addition, the liquid ejecting apparatus 1 is not limited to an ink jet printer, and may be a coloring material ejecting apparatus used for manufacturing a color filter such as a liquid crystal display, an electrode material ejecting apparatus used for forming an electrode such as an organic EL display and a field emission display (FED), a bioorganic substance ejecting apparatus used for manufacturing a biochip, a stereolithography apparatus, a textile printing apparatus, and the like.

In the following description, an X-axis, a Y-axis, and a Z-axis that are orthogonal to each other are used. In addition, in the following description, a starting point side of an arrow indicating a direction along the X-axis illustrated in the drawing may be referred to as a −X side, and a tip side may be referred to as a +X side. A starting point side of an arrow indicating a direction along the Y-axis illustrated in the drawing may be referred to as a −Y side, and a tip side may be referred to as a +Y side. A starting point side of an arrow indicating a direction along the Z-axis illustrated in the drawing may be referred to as a −Z side, and a tip side may be referred to as a +Z side. As illustrated in FIG. 2, in the liquid ejecting apparatus 1 of the present embodiment, the sub-scanning direction is located along the X-axis, the main scanning direction is located along the Y-axis, the medium P is transported along the X-axis such that the −X side is the upstream and the +X side is the downstream, and the carriage 110 is provided to reciprocate along the Y-axis.

As illustrated in FIG. 2, the liquid ejecting apparatus 1 includes a housing 100 and the carriage 110 which can reciprocate in the housing 100 in the Y-axis direction and on which one or a plurality of head units 3 are mounted. In addition, the carriage 110 is mounted with four ink cartridges 120 corresponding to inks of four colors of cyan, magenta, yellow, and black on a one-to-one basis. At this time, in the liquid ejecting apparatus 1 of the present embodiment, for example, a case where four head units 3 corresponding to the four ink cartridges 120 on a one-to-one basis are provided is assumed as an example.

The M ejecting sections D included in each of the four head units 3 receive supply of inks from the corresponding ink cartridge 120. Therefore, an inside of a total of 4M ejecting sections D included in each of the four head units 3 is filled with the ink supplied from the corresponding ink cartridge 120. Then, each of the total of 4M ejecting sections D included in each of the four head units 3 ejects the ink, with which the ejecting section D is filled, toward the medium P. The ink cartridge 120 may not be mounted on the carriage 110 and may be provided at an outside of the carriage 110.

In addition, the liquid ejecting apparatus 1 of the present embodiment includes, as the transport unit 7 described above, a carriage transport mechanism 71 for reciprocating the carriage 110 along the Y-axis, a carriage guide shaft 76 that supports the carriage 110 to reciprocate in the direction along the Y-axis, a medium transport mechanism 73 for transporting the medium P, and a platen 75 provided on the −Z side of the carriage 110. When executing the printing process, the transport unit 7 causes the carriage transport mechanism 71 to reciprocate the carriage 110 on which the head unit 3 is mounted along the Y-axis along the carriage guide shaft 76, and causes the medium transport mechanism 73 to transport the medium P from the −X side to the +X side along the X-axis on the platen 75 to change a relative position of the medium P with respect to the head unit 3. Therefore, the ink can land on the entire medium P.

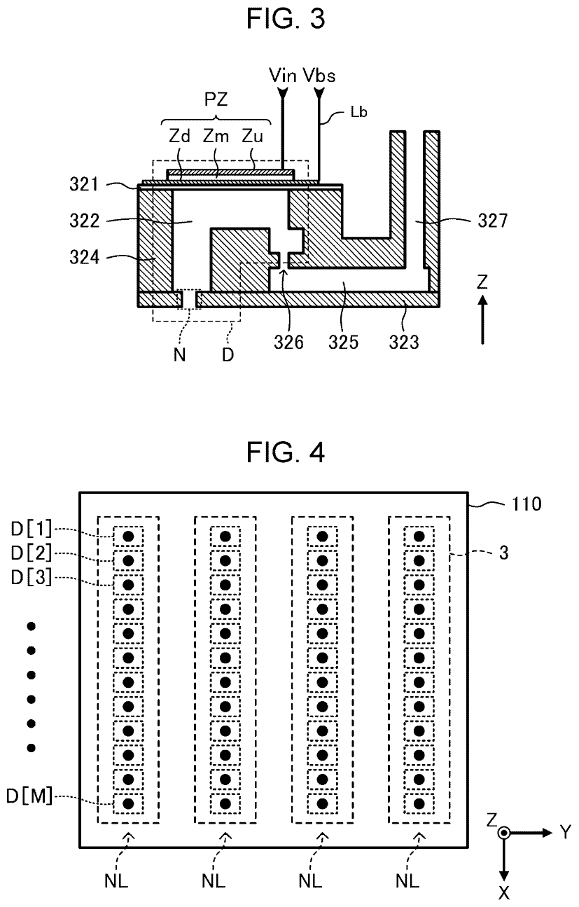

Here, an example of a structure of the ejecting section D that ejects an ink to the medium P will be described. FIG. 3 is a diagram illustrating a schematic structure of one ejecting section D. As illustrated in FIG. 3, the ejecting section D includes the piezoelectric element PZ, a cavity 322 of which an inside is filled with inks, a nozzle N communicating with the cavity 322, and a diaphragm 321. Then, in the ejecting section D, the piezoelectric element PZ is driven by supply of the supply drive signal Vin to the piezoelectric element PZ, and the ink stored in the inside of the cavity 322 is ejected from the nozzle N by the driving of the piezoelectric element PZ.

The cavity 322 is a space defined by a cavity plate 324, a nozzle plate 323 at which the nozzle N is formed, and the diaphragm 321. The cavity 322 communicates with a reservoir 325 via an ink supply port 326, and the reservoir 325 communicates with the ink cartridge 120 corresponding to the ejecting section D via the ink intake port 327. Therefore, the ink is supplied from the corresponding ink cartridge 120 to the inside of the cavity 322 via the ink intake port 327, the reservoir 325, and the ink supply port 326. Therefore, the inside of the cavity 322 is filled with the ink supplied from the corresponding ink cartridge 120.

The piezoelectric element PZ has an upper electrode Zu, a lower electrode Zd, and a piezoelectric body Zm. The piezoelectric body Zm is located between the upper electrode Zu and the lower electrode Zd. The supply drive signal Vin output by the supply circuit 31 is supplied to the upper electrode Zu. In addition, a reference voltage signal Vbs propagating through a wiring Lb is supplied to the lower electrode Zd. The piezoelectric body Zm has a potential difference between the upper electrode Zu and the lower electrode Zd, and is displaced on the +Z side or the −Z side along the Z-axis according to a potential difference between a voltage value of the supply drive signal Vin supplied to the upper electrode Zu and a voltage value of the reference voltage signal Vbs supplied to the lower electrode Zd. That is, the piezoelectric element PZ is driven to be displaced along the Z-axis to the +Z side or the −Z side according to the potential difference between the voltage value of the supply drive signal Vin and the voltage value of the reference voltage signal Vbs. Here, the reference voltage signal Vbs supplied to the lower electrode Zd is a signal that is a reference potential for driving the piezoelectric element PZ, and is a signal having a constant potential of 5.5 V, 6 V, a ground potential, or the like.

The lower electrode Zd is bonded to the diaphragm 321. Therefore, when the piezoelectric element PZ is driven to be displaced along the Z-axis by the supply drive signal Vin, the diaphragm 321 is also displaced along the Z-axis. An internal volume and an internal pressure of the cavity 322 are changed by the displacement of the diaphragm 321. Then, the ink with which the inside of the cavity 322 is filled is ejected from the nozzle N in response to the change in the internal volume and the internal pressure of the cavity 322. That is, the amount of ink according to the drive amount of the piezoelectric element PZ is ejected from the nozzle N of the ejecting section D.

That is, the piezoelectric element PZ ejects the amount of ink corresponding to the displacement generated by the supply of the supply drive signal Vin corresponding to the drive signal Com, from the ejecting section D.

FIG. 4 is a diagram illustrating an example of arrangement of the total of 4M ejecting sections D provided in the four head units 3 and the 4M nozzles N included in the 4M ejecting sections D. As illustrated in FIG. 4, the four head units 3 are located side by side along the Y-axis in the carriage 110. At this time, the four head units 3 are provided such that the M ejecting sections D and the nozzles N of each are located side by side along the X-axis.

Specifically, the ejecting sections D[1] to D[M], which are the M ejecting sections D included in the head unit 3, are located side by side in an order of the ejecting section D[1], the ejecting section D[2], the ejecting section D[3], . . . , and the ejecting section D[M] from the −X side to the +X side along the X-axis. That is, the head unit 3 includes a nozzle row NL in which the M nozzles N included in each of the M ejecting sections D are arranged side by side from the −X side to the +X side along the X-axis. Therefore, the nozzle row NL included in each of the four head units 3 is formed in four rows along the Y-axis in the carriage 110. The ink is ejected from each of the nozzles N forming the nozzle row NL included in each of the four head units 3.

### 2. CONFIGURATION OF HEAD UNIT

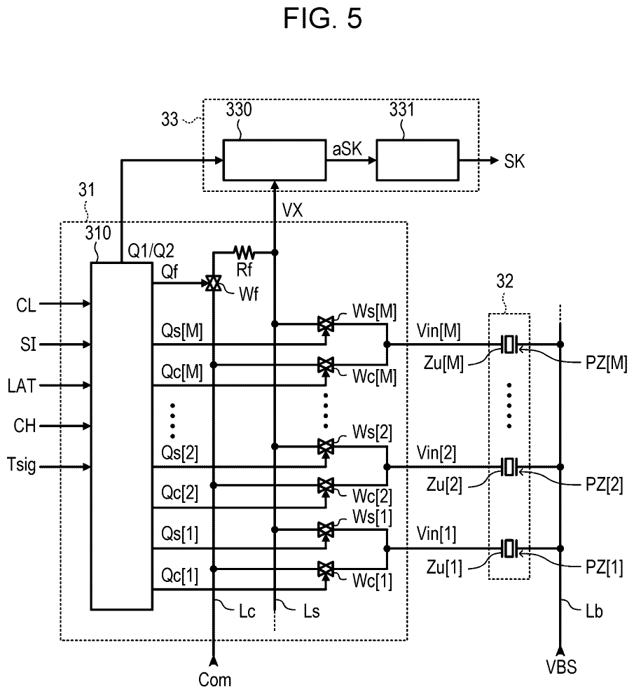

Next, a functional configuration of the head unit 3 will be described. FIG. 5 is a diagram illustrating an example of the functional configuration of the head unit 3. As described above, the head unit 3 includes the supply circuit 31, the recording head 32, and the detection circuit 33. In addition, in FIG. 5, in the head unit 3, a wiring Lc through which the drive signal Com propagates, the wiring Lb through which the reference voltage signal Vbs propagates, and a wiring Ls through which the detection potential signal VX propagates to the detection circuit 33 are illustrated.

The supply circuit 31 includes switches Wc[1] to Wc[M], switches Ws[1] to Ws[M], a switch Wf, a resistor Rf, and a coupling state designation circuit 310. The switches Wc[1] to Wc[M] and the switches Ws[1] to Ws[M] correspond to the ejecting sections D[1] to D[M] on a one-to-one basis, in the supply circuit 31.

The clock signal CL, the print data signal SI, the latch signal LAT, the change signal CH, and the period designation signal Tsig input to the head unit 3 are input to the coupling state designation circuit 310. The coupling state designation circuit 310 generates coupling state designation signals Qc[1] to Qc[M] for designating coupling states of the switches Wc[1] to Wc[M], coupling state designation signals Qs[1] to Qs[M] for designating coupling states of the switches Ws[1] to Ws[M], and a coupling state designation signal Qf for designating coupling state of the switch Wf, according to the print data signal SI propagated based on the clock signal CL in a period defined by the input latch signal LAT, the change signal CH, and the period designation signal Tsig, and outputs the signals to the corresponding switches Wc[1] to Wc[M], Ws[1] to Ws[M], and Wf.

The coupling state designation circuit 310 is configured to include a register that holds the print data signal SI propagated based on the clock signal CL in correspondence with the ejecting sections D[1] to D[M], and a decoder that decodes the print data signal SI held in the register to output the coupling state designation signals Qc[1] to Qc[M], Qs[1] to Qs[M], Qf, and the like having a predetermined logic level.

One end of the switch Wc[m] in the switch Wc[1] to Wc[M] is electrically coupled to the wiring Lc, and the other end is electrically coupled to the upper electrode Zu[m] of the piezoelectric element PZ[m] included in the ejecting section D[m]. The coupling state designation signal Qc[m] among the coupling state designation signals Qc[1] to Qc[M] is input to a control end of the switch Wc[m]. When the coupling state designation signal Qc[m] having a high level is input to the control end of the switch Wc[m], the switch Wc[m] becomes conductive between one end and the other end, and when the coupling state designation signal Qc[m] having a low level is input to the control end of the switch Wc[m], the switch Wc[m] becomes non-conductive between one end and the other end. That is, the switch Wc[m] switches a coupling state between the wiring Lc and the upper electrode Zu[m] according to a logic level of the coupling state designation signal Qc[m] input to the control end. Therefore, the switch Wc[m] switches whether or not to supply the drive signal Com propagating through the wiring Lc to the upper electrode Zu[m] of the ejecting section D[m] as the supply drive signal Vin[m] according to the coupling state designation signal Qc[m]. Such a switch Wc[m] is configured with, for example, a transmission gate.

One end of the switch Ws[m] in the switches Ws[1] to Ws[M] is electrically coupled to the wiring Ls, and the other end is electrically coupled to the upper electrode Zu[m] of the piezoelectric element PZ[m] included in the ejecting section D[m]. The coupling state designation signal Qs[m] among the coupling state designation signals Qs[1] to Qs[M] is input to a control end of the switch Ws[m]. When the coupling state designation signal Qs[m] having a high level is input to the control end of the switch Ws[m], the switch Ws[m] becomes conductive between one end and the other end, and when the coupling state designation signal Qs[m] having a low level is input to the control end of the switch Ws[m], the switch Ws[m] becomes non-conductive between one end and the other end. That is, the switch Ws[m] switches a coupling state between the wiring Ls and the upper electrode Zu[m] according to a logic level of the coupling state designation signal Qs[m] input to the control end. Therefore, the switch Ws[m] switches whether or not to supply a signal generated in the upper electrode Zu[m] of the piezoelectric element PZ[m] according to residual vibration generated in the ejecting section D[m] to the wiring Ls, according to the coupling state designation signal Qs[m]. Such a switch Ws[m] is configured with, for example, a transmission gate.

One end of the switch Wf is electrically coupled to the wiring Lc, and the other end is electrically coupled to one end of the resistor Rf. In addition, the other end of the resistor Rf is electrically coupled to the wiring Ls. That is, one end of the switch Wf is electrically coupled to the wiring Lc, and the other end is electrically coupled to the wiring Ls via the resistor Rf. The coupling state designation signal Qf is input to a control end of the switch Wf. When the coupling state designation signal Qf having a high level is input to the control end of the switch Wf, the switch Wf becomes conductive between one end and the other end, and when the coupling state designation signal Qf having a low level is input to the control end of the switch Wf, the switch Wf becomes non-conductive between one end and the other end. That is, the switch Wf switches a coupling state between the wiring Lc and the wiring Ls according to a logic level of the coupling state designation signal Qf input to the control end. Such a switch Wf is configured with, for example, a transmission gate.

Further, the coupling state designation circuit 310 generates coupling state designation signals Q1 and Q2 in a period defined by the input latch signal LAT, the change signal CH, and the period designation signal Tsig, and outputs the coupling state designation signals Q1 and Q2 to the detection circuit 33 according to the print data signal SI propagated based on the clock signal CL.

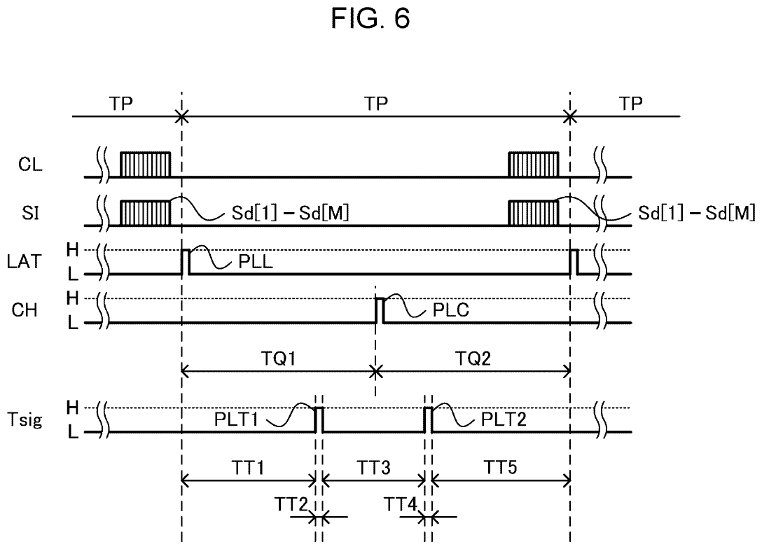

Here, an example of various signals input to the coupling state designation circuit 310 will be described. FIG. 6 is a diagram describing an example of various signals input to the coupling state designation circuit 310. As illustrated in FIG. 6, the liquid ejecting apparatus 1 of the present embodiment defines one or a plurality of unit periods TP as operation periods, and controls driving of the ejecting section D[m] and the operation of the detection circuit 33 in each of the defined unit periods TP.

Specifically, the control unit 2 generates the latch signal LAT including a pulse PLL and outputs the latch signal LAT to the coupling state designation circuit 310. For example, the control unit 2 may generate the latch signal LAT including the pulse PLL at a time based on at least one of a transport position of the medium P transported along the sub-scanning direction and a scanning position of the carriage 110 reciprocating along the main scanning direction, by setting a logic level of the latch signal LAT to a high level for a short time, and may output the latch signal LAT to the coupling state designation circuit 310. For example, the control unit 2 may generate the latch signal LAT including the pulse PLL by setting the logic level of the latch signal LAT to a high level for a short time at a predetermined time interval, and output the latch signal LAT to the coupling state designation circuit 310. A period from a rising edge of the pulse PLL included in the latch signal LAT to the next rising edge of the pulse PLL corresponds to the unit period TP described above.

Further, the control unit 2 generates the change signal CH including a pulse PLC, and outputs the change signal CH to the coupling state designation circuit 310. For example, the control unit 2 generates the change signal CH including the pulse PLC by setting a logic level of the change signal CH to a high level for a short time at a time when a predetermined time elapses from the rising edge of the pulse PLL, and outputs the change signal CH to the coupling state designation circuit 310. The pulse PLC included in the change signal CH divides the unit period TP into a control period TQ1 and a control period TQ2. Specifically, the change signal CH divides the unit period TP into the control period TQ1 which is a period from the rising edge of the pulse PLL to a rising edge of the pulse PLC, and the control period TQ2 which is a period from the rising edge of the pulse PLC to the rising edge of the pulse PLL. The number of divisions into which the unit period TP is divided by the change signal CH is not limited to two.

The control unit 2 generates the period designation signal Tsig including pulses PLT1 and PLT2, and outputs the period designation signal Tsig to the coupling state designation circuit 310. For example, the control unit 2 generates the pulse PLT1 by setting a logic level of the period designation signal Tsig to a high level at a time when a predetermined time elapses from the rising edge of the pulse PLL, and then setting the logic level of the period designation signal Tsig to a low level, and outputs the pulse PLT1 to the coupling state designation circuit 310, and then generates the pulse PLT2 by setting the logic level of the period designation signal Tsig to a high level at a time when a predetermined time elapses, and then setting the logic level of the period designation signal Tsig to a low level, and outputs the pulse PLT2 to the coupling state designation circuit 310. The pulses PLT1 and PLT2 included in the period designation signal Tsig divide the unit period TP into control periods TT1 to TT5. Specifically, in the period designation signal Tsig, the unit period TP is divided into the control period TT1, which is a period from the rising edge of the pulse PLL to the rising edge of the pulse PLT1, the control period TT2, which is a period from the rising edge of the pulse PLT1 to a falling edge of the pulse PLT1, the control period TT3, which is a period from the falling edge of the pulse PLT1 to a rising edge of the pulse PLT2, the control period TT4, which is a period from the rising edge of the pulse PLT2 to a falling edge of the pulse PLT2, and the control period TT5, which is a period from the falling edge of the pulse PLT2 to the rising edge of the pulse PLL. The number of divisions into which the unit period TP is divided by the period designation signal Tsig is not limited to five.

Further, the control unit 2 generates the print data signal SI serially including individual designation signals Sd[1] to Sd[M], and outputs the print data signal SI to the coupling state designation circuit 310. Each of the individual designation signals Sd[1] to Sd[M] is a signal including 3-bit information, and defines a driving mode of each of the ejecting sections D[1] to D[M]. Here, in the following description, the 3-bit information included in the individual designation signal Sd[m] may be referred to as bits S1, S2, and S3, and the individual designation signal Sd[m] may be expressed as Sd[m]=[S1, S2, S3]. Further, in the following description, a case where the bits S1, S2, and S3 included in the individual designation signal Sd[m] may be any of “1” and “O” may be expressed by using “*”.

Specifically, before the unit period TP to be controlled, the control unit 2 generates the print data signal SI including the individual designation signals Sd[1] to Sd[M] that define the driving mode of the ejecting sections D[1] to D[M] or the operation of the detection circuit 33 in the unit period TP to be controlled, and outputs the print data signal SI to the coupling state designation circuit 310. The print data signal SI is held in a register (not illustrated) in the coupling state designation circuit 310 in a state in which the individual designation signals Sd[1] to Sd[M] correspond to the ejecting sections D[1] to D[M], respectively. Then, when the unit period TP to be controlled arrives, the coupling state designation circuit 310 simultaneously latches the 3-bit information included in each of the held individual designation signals Sd[1] to Sd[M], and decodes the latched 3-bit information. Thus, the coupling state designation circuit 310 generates the coupling state designation signals Qc[1] to Qc[M], Qs[m] to Qs[M], Qf, Q1, and Q2 of the logic level according to the decoding content in each of the control periods TQ1 and TQ2 in the unit period TP to be controlled, or in each of the control periods TT1 to TT5, and outputs the generated signals to control ends of the corresponding switches Wc[1] to Wc[M], Ws[1] to Ws[M], Wf, W1, and W2.

Therefore, a conduction state of each of the switches Wc[1] to Wc[M], Ws[1] to Ws[M], Wf, W1, and W2 in each of the control periods TQ1 and TQ2 or each of the control periods TT1 to TT5 is controlled. As a result, the driving mode of the ejecting sections D[1] to D[M] or the operation of the detection circuit 33 in each of the control periods TQ1 and TQ2 or each of the control periods TT1 to TT5 is controlled.

With reference to FIG. 5, the detection potential signal VX propagating through the wiring Ls and the coupling state designation signals Q1 and 02 output by the coupling state designation circuit 310 are input to the detection circuit 33. In addition, the detection circuit 33 includes a waveform shaping circuit 330 and an AD conversion circuit 331. The waveform shaping circuit 330 acquires the detection potential signal VX in accordance with the coupling state designation signals Q1 and Q2. The waveform shaping circuit 330 removes a noise from the acquired detection potential signal VX and amplifies the detection potential signal VX to shape a signal waveform of the detection potential signal VX and output the shaped signal waveform as a detection signal aSK. The AD conversion circuit 331 converts the detection signal aSK of the analog signal output by the waveform shaping circuit 330 into a digital signal and outputs the digital signal as the detection signal SK. The detection signal SK is output from the detection circuit 33 and the head unit 3. That is, the detection circuit 33 changes a signal according to residual vibration generated in the ejecting section D into a digital signal and outputs the digital signal as the detection signal SK.

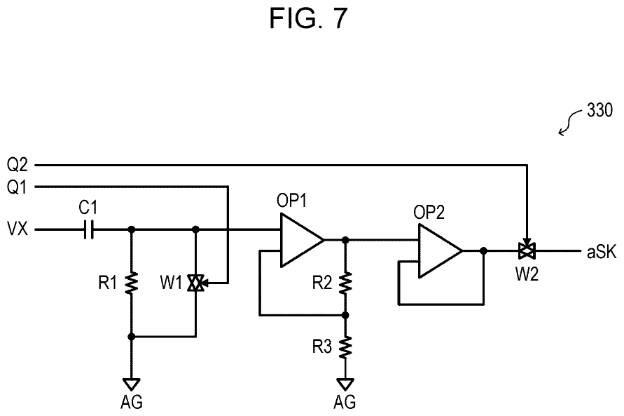

Here, an example of a configuration of the waveform shaping circuit 330 included in the detection circuit 33 will be described. FIG. 7 is a diagram illustrating an example of a configuration of the waveform shaping circuit 330. As illustrated in FIG. 7, the waveform shaping circuit 330 includes a capacitor C1, operational amplifiers OP1 and OP2, the switches W1 and W2, and resistors R1 to R3.

The detection potential signal VX output by the supply circuit 31 is input to one end of the capacitor C1. The other end of the capacitor C1 is electrically coupled to one end of the resistor R1 and one end of the switch W1. An analog ground AG fixed to a constant potential is supplied to the other end of the resistor R1 and the other end of the switch W1. That is, the resistor R1 and the switch W1 are coupled in parallel. The coupling state designation signal Q1 is input to the control end of the switch W1. When the coupling state designation signal Q1 having a high level is input to the control end of the switch W1, the switch W1 becomes conductive between one end and the other end, and when the coupling state designation signal Q1 having a low level is input to the control end of the switch W1, the switch W1 becomes non-conductive between one end and the other end. That is, the switch W1 switches a conduction state between one end of the resistor R1 and the analog ground AG. The capacitor C1, the resistor R1, and the switch W1 configured as described above function as a high-pass filter, and extract and output a signal of a predetermined high frequency component from the detection potential signal VX input during a period in which the switch W1 is controlled to be non-conductive. Here, the switch W1 may be configured with, for example, a transmission gate. In addition, the analog ground AG may be a center potential between a power supply potential on a high-potential side supplied to the head unit 3 and a power supply potential on a low-potential side.

A +side input terminal of the operational amplifier OP1 is electrically coupled to a coupling point at which the other end of the capacitor C1, one end of the resistor R1, and one end of the switch W1 are electrically coupled. That is, a signal output by the high-pass filter configured with the capacitor C1, the resistor R1, and the switch W1 is input to the +side input terminal of the operational amplifier OP1. A −side input terminal of the operational amplifier OP1 is electrically coupled to a coupling point at which one end of the resistor R2 and one end of the resistor R3 are electrically coupled. An output terminal of the operational amplifier OP1 is electrically coupled to the other end of the resistor R2. The analog ground AG is supplied to the other end of the resistor R3. That is, the operational amplifier OP1 and the resistors R2 and R3 function as a non-inverting amplifier circuit that amplifies a signal input to the +side input terminal of the operational amplifier OP1 according to resistance values of the resistors R2 and R3 and outputs the signal from the output terminal of the operational amplifier OP1. Here, the non-inverting amplifier circuit configured with the operational amplifier OP1 and the resistors R2 and R3 may be configured to output a signal obtained by superimposing a predetermined offset voltage on a signal output by the high-pass filter including the capacitor C1, the resistor R1, and the switch W1, and then amplifying the signal.

A +side input terminal of the operational amplifier OP2 is electrically coupled to the output terminal of the operational amplifier OP1. That is, a signal output by the non-inverting amplifier circuit configured with the operational amplifier OP1 and the resistors R2 and R3 is input to the +side input terminal of the operational amplifier OP2. A −side input terminal of the operational amplifier OP2 is electrically coupled to an output terminal of the operational amplifier OP2. That is, a voltage follower circuit is configured with the operational amplifier OP2. Therefore, the operational amplifier OP2 converts an impedance of a signal output by the non-inverting amplifier circuit configured with the operational amplifier OP1 and the resistors R2 and R3, and outputs the signal.

One end of the switch W2 is electrically coupled to the output terminal of the operational amplifier OP2. A signal at the other end of the switch W2 is output as the detection signal aSK from the waveform shaping circuit 330. In addition, the coupling state designation signal Q2 is input to the control end of the switch W2. When the coupling state designation signal Q2 having a high level is input to the control end of the switch W2, the switch W2 becomes conductive between one end and the other end, and when the coupling state designation signal Q2 having a low level is input to the control end of the switch W2, the switch W2 becomes non-conductive between one end and the other end. The switch W2 switches whether or not to output a signal output by the operational amplifier OP2 as the detection signal aSK from the waveform shaping circuit 330 according to a logic level of the coupling state designation signal Q2 input to the control end.

As described above, the waveform shaping circuit 330 removes a noise component from the detection potential signal VX by the high-pass filter configured with the capacitor C1, the resistor R1, and the switch W1, and amplifies the signal, from which the noise component is removed, by the non-inverting amplifier circuit configured with the operational amplifier OP1, and the resistors R2 and R3. The waveform shaping circuit 330 performs impedance conversion by a voltage follower circuit configured with the operational amplifier OP2, and then outputs the detection signal aSK. At this time, the switches W1 and W2 switch whether or not the waveform shaping circuit 330 acquires and outputs the detection potential signal VX as the detection signal aSK.

The detection signal aSK output by the waveform shaping circuit 330 is input to the AD conversion circuit 331. The AD conversion circuit 331 converts the detection signal aSK into a digital signal. The converted digital signal by the AD conversion circuit 331 is output as the detection signal SK from the detection circuit 33 and the head unit 3.

In the head unit 3 of the present embodiment configured as described above, the supply circuit 31 controls the conduction state of the switch Wc[m] according to the print data signal SI propagated based on the clock signal CL in each of the control periods TQ1 and TQ2 or the control periods TT1 to TT5 defined by the latch signal LAT, the change signal CH, and the period designation signal Tsig, and thus switches whether or not to supply the drive signal Com propagating through the wiring Ls to the piezoelectric element PZ[m] of the ejecting section D[m] as the supply drive signal Vin[m]. Therefore, the driving mode of the ejecting section D[m] is controlled.

In addition, in the head unit 3 of the present embodiment, the supply circuit 31 controls the conduction state of the switch Ws[m] according to the print data signal SI propagated based on the clock signal CL in each of the control periods TQ1 and TO2 or the control periods TT1 to TT5 defined by the latch signal LAT, the change signal CH, and the period designation signal Tsig, and thus switches whether or not to acquire a signal according to residual vibration generated in the ejecting section D[m] and to output the signal to the detection circuit 33 as the detection potential signal VX. At this time, the detection circuit 33 amplifies and shapes a signal waveform of the input detection potential signal VX, according to the conduction state of the switches W1 and W2, and outputs the signal waveform as the detection signal SK. The detection signal SK output by the detection circuit 33 is input to the determination unit 8. Then, the determination unit 8 determines a state of the target ejecting section D[m] based on the input detection signal SK.

Here, the supply circuit 31 included in the head unit 3 is configured with one or a plurality of semiconductor devices. In addition, at this time, a part or all of the detection circuit 33 may be mounted in the semiconductor device together with the supply circuit 31.

As described above, the liquid ejecting apparatus 1 of the present embodiment includes the plurality of ejecting sections D that include the piezoelectric element PZ to which the supply drive signal Vin in accordance with the drive signal Com is supplied, and eject the inks in response to driving of the piezoelectric element PZ and output a signal according to residual vibration generated after the piezoelectric element PZ is driven, the detection circuit 33 that acquires any signal according to the residual vibration generated after the piezoelectric element PZ is driven, which is output by each of the plurality of ejecting sections D, and outputs the detection signal SK in accordance with the acquired signal, the switches Ws[1] to Ws[m] that switch whether or not to supply the signal according to the residual vibration generated after the piezoelectric element PZ is driven to the detection circuit 33, the storage unit 9 that stores correction value information of the detection signal SK, and the determination unit 8 that determines a state of the ejecting section in accordance with the detection signal SK and the correction value information.

### 3. OPERATION OF LIQUID EJECTING APPARATUS AND HEAD UNIT DURING EXECUTION OF PRINTING PROCESS

An operation of the liquid ejecting apparatus 1 including the head unit 3 configured as described above will be described. As described above, a printing process in which the liquid ejecting apparatus 1 of the present embodiment forms an image in accordance with the image data Img includes an ejection process of forming dots at a desired position on the medium P by ejecting an ink to the medium P, and a state determination process of determining a state of the ejecting section D that ejects the ink to the medium P. In the following, the operation of the liquid ejecting apparatus 1 in a period in which the printing process is being executed will be described, and the operation of the liquid ejecting apparatus 1 in each of the ejection process and the state determination process will be described.

### 3.1 Ejection Process

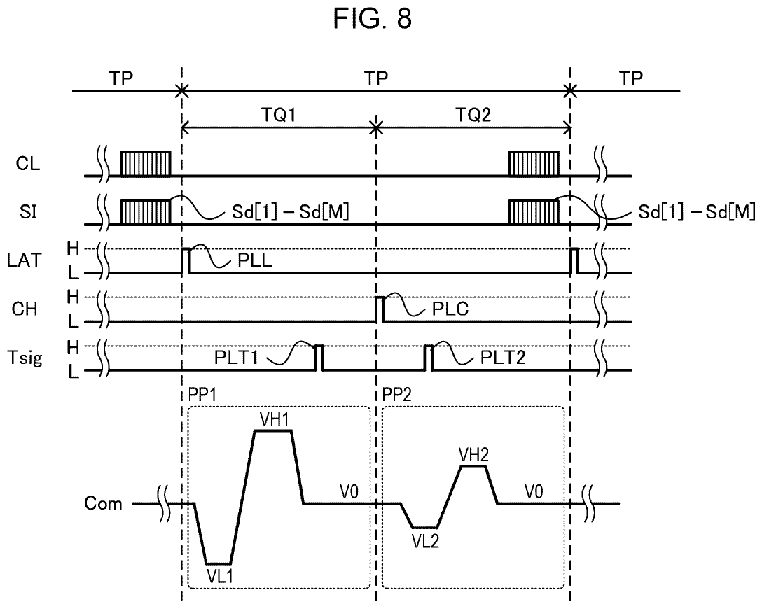

FIG. 8 is a diagram describing an example of various signals supplied to the head unit 3 during a period in which an ejection process is being executed.

The control unit 2 generates the drive waveform designation signal dCom that defines a signal waveform of the drive signal Com output by the drive signal output unit 4 in the period in which the ejection process is being executed, and outputs the drive waveform designation signal dCom to the drive signal output unit 4. Therefore, the drive signal output unit 4 generates the drive signal Com having a signal waveform in which the drive waveform PP1 to be disposed in the control period TQ1 and the drive waveform PP2 to be disposed in the control period TQ2 are continuous for each unit period TP as illustrated in FIG. 8, in accordance with the input drive waveform designation signal dCom, and supplies the drive signal Com to the head unit 3.

The drive waveform PP1 is a signal waveform that starts with a voltage value of a reference potential V0, changes to a potential VL1 having a potential lower than the reference potential V0, changes to a potential VH1 having a potential higher than the reference potential V0, and then ends with the reference potential V0. When the drive waveform PP1 is supplied to the piezoelectric element PZ[m], the piezoelectric element PZ[m] is driven such that an ink having an ink amount ξ1 is ejected from the nozzle N[m]. That is, the drive waveform PP1 is a signal waveform for ejecting the ink having the ink amount ξ1 from the nozzle N[m].

The drive waveform PP2 is a signal waveform that starts with a voltage value of the reference potential V0, changes to a potential VL2 having a potential lower than the reference potential V0, changes to a potential VH2 having a potential higher than the reference potential V0, and then ends with the reference potential V0. When the drive waveform PP2 is supplied to the piezoelectric element PZ[m], the piezoelectric element PZ[m] is driven such that the ink having an ink amount ξ2 is ejected from the nozzle N[m]. That is, the drive waveform PP2 is a signal waveform for ejecting the ink having the ink amount ξ2 from the nozzle N[m].

Here, in the liquid ejecting apparatus 1 of the present embodiment, multi-gradation dot formation on the medium P is realized by forming any one of a large dot, a medium dot smaller than the large dot, and a small dot smaller than the medium dot on the medium P, or by performing non-recording in which the dot is not formed, for each unit period TP in the period in which the ejection process is being executed. That is, the ejecting section D[m] can select to eject the amount of ink corresponding to any of the large dot, the medium dot, and the small dot or not to eject the ink, for each unit period TP in the period in which the ejection process is being executed.

The liquid ejecting apparatus 1 of the present embodiment is described such that the ink amount ξ1 ejected from the ejecting section D[m] when the drive waveform PP1 is supplied to the piezoelectric element PZ[m] is an ink amount corresponding to the medium dot described above, the ink amount ξ2 ejected from the ejecting section D[m] when the drive waveform PP2 is supplied to the piezoelectric element PZ[m] is smaller than the ink amount ξ1 and is an ink amount corresponding to the small dot described above, and a total amount of ink amount ξ1 and ink amount ξ2 is an ink amount corresponding to the large dot described above.

Further, in the period in which the liquid ejecting apparatus 1 of the present embodiment executes the ejection process, the individual designation signal Sd[m] input to the coupling state designation circuit 310 defines the conduction state of the switch Wc[m] in each of the control periods TQ1 and TQ2. Therefore, whether to supply the supply drive signal Vin[m] including the drive waveform PP1 disposed in the control period TQ1 and the drive waveform PP2 disposed in the control period TQ2 to the ejecting section D[m], to supply the supply drive signal Vin[m] including the drive waveform PP1 disposed in the control period TQ1 to the ejecting section D[m], to supply the supply drive signal Vin[m] including the drive waveform PP2 disposed in the control period TQ2 to the ejecting section D[m], or to supply the supply drive signal Vin[m] including neither the drive waveform PP1 disposed in the control period TQ1 nor the drive waveform PP2 disposed in the control period TQ2 to the ejecting section D[m] is controlled, for each unit period TP. Therefore, in the unit period TP in which the ejection process is being executed by the liquid ejecting apparatus 1, whether to eject the amount of ink corresponding to the large dot, the amount of ink corresponding to the medium dot, the amount of ink corresponding to the small dot, or not to eject the ink from the ejecting section D[m] is defined. Therefore, a dot size to be formed on the medium P is controlled.

Here, an example of decoding contents of the individual designation signals Sd[1] to Sd[M] executed by the coupling state designation circuit 310 will be described in a relationship between the individual designation signals Sd[1] to Sd[M] included in the print data signal SI input to the coupling state designation circuit 310 and the coupling state designation signals Qc[1] to Qc[M] and Qs[1] to Qs[M] output by the coupling state designation circuit 310, in the period in which the liquid ejecting apparatus 1 executes the ejection process.

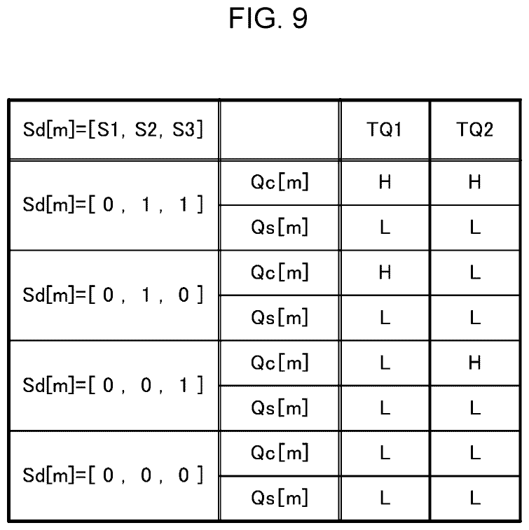

FIG. 9 is a diagram illustrating an example of a relationship between the individual designation signal Sd[m] and the coupling state designation signals Qc[m] and Qs[m] in a period in which an ejection process is being executed.

As illustrated in FIG. 9, when the individual designation signal Sd[m]=[0, 1, 1] is input to the coupling state designation circuit 310, the coupling state designation circuit 310 generates the coupling state designation signal Qc[m] that is at a high level in the control period TQ1 and is at a high level in the control period TQ2, and outputs the coupling state designation signal Qc[m] to the control end of the switch Wc[m]. Therefore, the switch Wc[m] is controlled to be conductive in the control period TO1 and is controlled to be conductive in the control period TQ2. Therefore, the supply drive signal Vin[m] including the drive waveform PP1 is supplied to the piezoelectric element PZ[m] in the control period TQ1, and the supply drive signal Vin[m] including the drive waveform PP2 is supplied to the piezoelectric element PZ[m] in the control period TQ2. As a result, an ink having the ink amount ξ1 is ejected from the nozzle N[m] in the control period TQ1, and an ink having the ink amount ξ2 is ejected from the nozzle N[m] in the control period TQ2. Then, the ink of the ink amount ξ1 ejected in the control period TQ1 and the ink of the ink amount 82 ejected in the control period TQ2 land on the medium P and are combined with each other, so that a large dot is formed on the medium P in the unit period TP.

Further, when the individual designation signal Sd[m]=[0, 1, 0] is input to the coupling state designation circuit 310, the coupling state designation circuit 310 generates the coupling state designation signal Qc[m] that is at a high level in the control period TQ1 and is at a low level in the control period TQ2, and outputs the coupling state designation signal Qc[m] to the control end of the switch Wc[m]. Therefore, the switch Wc[m] is controlled to be conductive in the control period TQ1 and controlled to be non-conductive in the control period TQ2. Therefore, the supply drive signal Vin[m] including the drive waveform PP1 is supplied to the piezoelectric element PZ[m] in the control period TQ1, and the supply drive signal Vin[m] including the drive waveform PP2 is not supplied to the piezoelectric element PZ[m] in the control period TQ2. Here, in the control period TQ2 in which the supply drive signal Vin[m] including the drive waveform PP2 is not supplied to the piezoelectric element PZ[m], the reference potential V0 is held by a capacitive component of the piezoelectric element PZ[m] in the upper electrode Zu[m], which is a voltage value of a signal supplied immediately before to the upper electrode Zu[m]. That is, in the control period TQ2 in which the supply drive signal Vin[m] including the drive waveform PP2 is not supplied to the piezoelectric element PZ[m], a constant signal at the reference potential V0 is supplied to the upper electrode Zu[m]. As a result, the ink having the ink amount ξ1 is ejected from the nozzle N[m] in the control period TQ1, and the ink is not ejected in the control period TQ2. Then, the ink of the ink amount ξ1 ejected in the control period TQ1 lands on the medium P, so that a medium dot is formed on the medium P in the unit period TP.

Further, when the individual designation signal Sd[m]=[0, 0, 1] is input to the coupling state designation circuit 310, the coupling state designation circuit 310 generates the coupling state designation signal Qc[m] that is at a low level in the control period TO1 and is at a high level in the control period TQ2, and outputs the coupling state designation signal Qc[m] to the control end of the switch Wc[m]. Therefore, the switch Wc[m] is controlled to be non-conductive in the control period TQ1 and is controlled to be conductive in the control period TQ2. Therefore, the supply drive signal Vin[m] including the drive waveform PP1 is not supplied to the piezoelectric element PZ[m] in the control period TQ1, and the supply drive signal Vin[m] including the drive waveform PP2 is supplied to the piezoelectric element PZ[m] in the control period TQ2. Here, in the control period TQ1 in which the supply drive signal Vin[m] including the drive waveform PP1 is not supplied to the piezoelectric element PZ[m], the reference potential V0 is held by a capacitive component of the piezoelectric element PZ[m] in the upper electrode Zu[m], which is a voltage value of a signal supplied immediately before to the upper electrode Zu[m]. That is, in the control period TQ1 in which the supply drive signal Vin[m] including the drive waveform PP1 is not supplied to the piezoelectric element PZ[m], a constant signal at the reference potential V0 is supplied to the upper electrode Zu[m]. As a result, the ink is not ejected from the nozzle N[m] in the control period TQ1, and the ink having the ink amount ξ2 is ejected from the nozzle N[m] in the control period TQ2. Then, the ink of the ink amount ξ2 ejected in the control period TQ2 lands on the medium P, so that a small dot is formed on the medium P in the unit period TP.

Further, when the individual designation signal Sd[m]=[0, 0, 0] is input to the coupling state designation circuit 310, the coupling state designation circuit 310 generates the coupling state designation signal Qc[m] that is at a low level in the control period TQ1 and is at a low level in the control period TQ2, and outputs the coupling state designation signal Qc[m] to the control end of the switch Wc[m]. Therefore, the switch Wc[m] is controlled to be non-conductive in the control period TQ1 and is controlled to be non-conductive in the control period TQ2. Therefore, the supply drive signal Vin[m] including the drive waveform PP1 is not supplied to the piezoelectric element PZ[m] in the control period TQ1, and the supply drive signal Vin[m] including the drive waveform PP2 is not supplied to the piezoelectric element PZ[m] in the control period TQ2. Here, in the control period TQ1 in which the supply drive signal Vin[m] including the drive waveform PP1 is not supplied to the piezoelectric element PZ[m] and the control period TQ2 in which the supply drive signal Vin[m] including the drive waveform PP2 is not supplied to the piezoelectric element PZ[m], the reference potential V0 is held by a capacitive component of the piezoelectric element PZ[m] in the upper electrode Zu[m], which is a voltage value of a signal supplied immediately before to the upper electrode Zu[m]. That is, in the control period TQ1 in which the supply drive signal Vin[m] including the drive waveform PP1 is not supplied to the piezoelectric element PZ[m], and in the control period TQ2 in which the supply drive signal Vin[m] including the drive waveform PP2 is not supplied, a constant signal at the reference potential V0 is supplied to the upper electrode Zu[m]. As a result, the ink is not ejected from the nozzle N[m] in the control period TQ1, and the ink is not ejected from the nozzle N[m] in the control period TQ2. Therefore, dots are not formed on the medium P in the unit period TP.

As described above, when the liquid ejecting apparatus 1 executes the ejection process, the coupling state designation circuit 310 outputs the coupling state designation signals Qs[1] to Qs[M] having the logic levels based on the individual designation signals Sd[1] to Sd[M], in each of the control periods TQ1 and TQ2 in the unit period TP. Therefore, the conduction states of the switches Wc[1] to Wc[m] in the control periods TQ1 and TQ2 in the unit period TP are controlled, and the ejection amount of ink to be ejected from each of the ejecting sections D[1] to D[M] in the control periods TQ1 and TQ2 in the unit period TP is controlled. That is, a dot size to be formed on the medium P in the unit period TP is controlled. Therefore, the liquid ejecting apparatus 1 can form an image corresponding to the image data Img on the medium P in the period in which the ejection process is being executed.

Here, as illustrated in FIG. 9, in the period in which the liquid ejecting apparatus 1 executes the ejection process, the coupling state designation circuit 310 continues to output the coupling state designation signal Qs[m] having a low level, regardless of the input individual designation signal Sd[m]. Therefore, the switch Ws[m] is controlled to be non-conductive in the period in which the ejection process is being executed. As a result, the upper electrode Zu[m] and the wiring Ls are not electrically coupled to each other during the period in which the liquid ejecting apparatus 1 executes the ejection process. Therefore, a signal according to residual vibration generated in the ejecting section D[m] is not supplied to the detection circuit 33. Therefore, the detection circuit 33 does not acquire the detection potential signal VX in the period in which the liquid ejecting apparatus 1 executes the ejection process. Therefore, although not illustrated, in the period in which the liquid ejecting apparatus 1 executes the ejection process, the coupling state designation circuit 310 continues to output the coupling state designation signals Qf, Q1, and Q2 having a low level.

### 3.2 State Determination Process

Next, a state determination process of determining a state of the ejecting section D that ejects an ink to the medium P in a printing process will be described. It is known that residual vibration is generated in an ejecting section that ejects a liquid such as an ink by driving a driving element such as a piezoelectric element after the driving element is driven. The residual vibration generated in the ejecting section is so-called attenuation vibration in which an amplitude is decreased with the passage of time, and waveform information such as the amplitude, an amplitude attenuation factor, a period, and a frequency of the attenuation vibration is changed depending on a state of the ejecting section. For example, when a viscosity of the liquid stored in the ejecting section is changed, the amplitude of the residual vibration generated in the ejecting section or the amplitude attenuation factor is changed. When air bubbles are mixed into an inside of the ejecting section, for example, the frequency of the residual vibration generated in the ejecting section is increased.

In the liquid ejecting apparatus 1 of the present embodiment, in the state determination process of determining the state of the ejecting section D that ejects the ink to the medium P, the supply circuit 31 included in the head unit 3 acquires a signal according to the residual vibration generated in the ejecting section D[m] as an inspection target and outputs the signal to the detection circuit 33 as the detection potential signal VX, and the detection circuit 33 generates the detection signal SK by shaping a signal waveform of the input detection potential signal VX. The determination unit 8 calculates waveform information such as the amplitude, the period, and the frequency of the detection potential signal VX based on the input detection signal SK, and calculates waveform information such as the amplitude, the period, and the frequency of the residual vibration generated in the ejecting section D[m] as an inspection target based on the calculated waveform information. The determination unit 8 determines the state of the ejecting section D[m] as an inspection target based on the calculated waveform information. The determination unit 8 generates the ejection state determination information JH indicating a determination result and outputs the ejection state determination information JH to the control unit 2. Therefore, the control unit 2 can acquire the state of the ejecting section D[m] as an inspection target, correct the various signals to be output in accordance with the acquired state of the ejecting section D[m] as an inspection target, or notify a user of the state of the ejecting section D[m] as an inspection target.

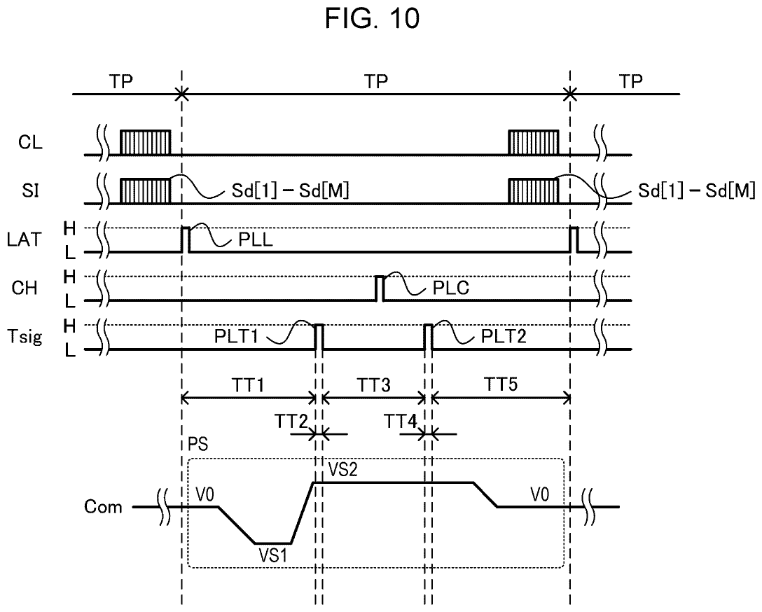

FIG. 10 is a diagram describing an example of various signals input to the supply circuit 31 of the head unit 3 during a period in which a state determination process is being executed.

The control unit 2 generates the drive waveform designation signal dCom that defines a signal waveform of the drive signal Com output by the drive signal output unit 4 in the period in which the state determination process is being executed, and outputs the drive waveform designation signal dCom to the drive signal output unit 4. Therefore, the drive signal output unit 4 generates the drive signal Com including a drive waveform PS for each unit period TP as illustrated in FIG. 10, in accordance with the input drive waveform designation signal dCom, and supplies the drive signal Com to the head unit 3.

The drive waveform PS is a signal waveform in which a voltage value starts at the reference potential V0, changes to the potential VS1 having a potential lower than the reference potential V0, and is at a potential VS2 having a potential higher than the reference potential V0 in the control period TT1, maintains the potential VS2 in the control periods TT2, TT3, and TT4, and ends at the reference potential V0 in the control period TT5. When the drive waveform PS is supplied to the piezoelectric element PZ[m], the piezoelectric element PZ[m] is driven such that an ink is not ejected from the nozzle N[m], and residual vibration is generated in the ejecting section D[m] at a time when a voltage value of the drive signal Com is at the potential VS2 after the piezoelectric element PZ[m] is driven. That is, the drive waveform PS is a signal waveform for driving the piezoelectric element PZ[m] such that the ink is not ejected from the nozzle N[m] and predetermined residual vibration is generated in the ejecting section D[m], and when the drive waveform PS is supplied, the piezoelectric element PZ[m] is driven such that the ink is not ejected from the ejecting section D[m] and the residual vibration is generated.

In the period in which the liquid ejecting apparatus 1 executes the state determination process, the coupling state designation circuit 310 controls the conduction states of the switches Wc[1] to Wc[M], Ws[1] to Ws[M], Wf, W1, and W2 based on the individual designation signals Sd[1] to Sd[M] included in the print data signal SI in each of the control periods TT1 to TT5, and supplies the supply drive signal Vin[m] including the drive waveform PS to the ejecting section D[m] as an inspection target, and acquires a signal according to residual vibration generated in the ejecting section D[m] as an inspection target due to the supply of the supply drive signal Vin[m] including the drive waveform PS, and outputs the acquired signal to the detection circuit 33 as the detection potential signal VX. The detection circuit 33 generates the detection signal SK by shaping a signal waveform of the input detection potential signal VX, and the determination unit 8 determines a state of the ejecting section D[m] as an inspection target based on the detection signal SK.

Here, the state determination process in the liquid ejecting apparatus 1 of the present embodiment includes a determination process of acquiring the detection potential signal VX based on the signal according to the residual vibration generated in the ejecting section D[m] as an inspection target, and determining the state of the ejecting section D[m] as an inspection target based on the acquired detection potential signal VX, and a determination preparation process of enhancing determination accuracy for the state of the ejecting section D[m] as an inspection target in the determination process.

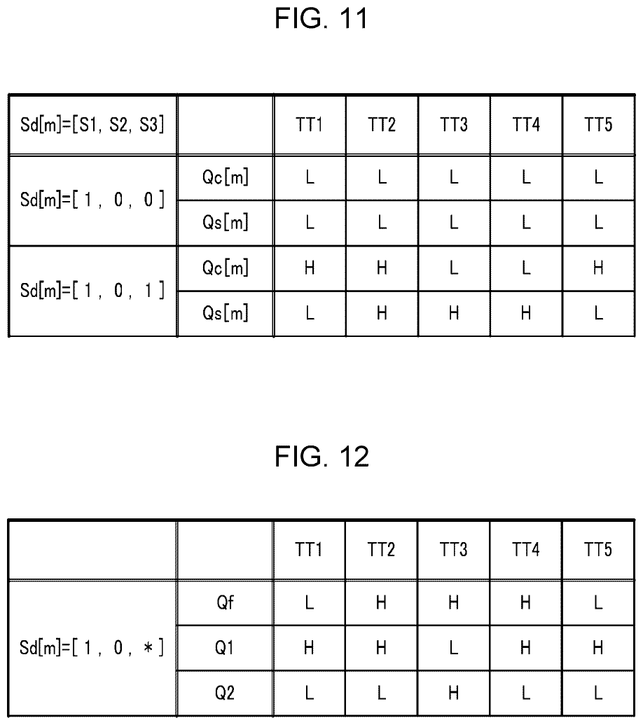

First, an example of a decoding content of the individual designation signals Sd[1] to Sd[M] executed by the coupling state designation circuit 310, in a period in which the liquid ejecting apparatus 1 executes a determination process, in a relationship between the individual designation signals Sd[1] to Sd[M] included in the print data signal SI input to the coupling state designation circuit 310 and the coupling state designation signals Qc[1] to Qc[M], Qs[1] to Qs[M], Qf, Q1, and Q2 output by the coupling state designation circuit 310 in the period in which the determination process is being executed will be described. FIG. 11 is a diagram illustrating an example of a relationship between the individual designation signal Sd[m] and the coupling state designation signals Qc[m] and Qs[m] in the period in which the determination process is being executed. Here, the liquid ejecting apparatus 1 of the present embodiment will be described such that in the determination process, the control unit 2 outputs the individual designation signal Sd[m]=[1, 0, 0] to the coupling state designation circuit 310 when the ejecting section D[m] is not an inspection target, and outputs the individual designation signal Sd[m]=[1, 0, 1] to the coupling state designation circuit 310 when the ejecting section D[m] is the inspection target.

As illustrated in FIG. 11, when the individual designation signal Sd[m]=[1, 0, 0] is input to the coupling state designation circuit 310, the coupling state designation circuit 310 generates the coupling state designation signal Qc[m] that is at a low level in the control periods TT1 to TT5 and outputs the coupling state designation signal Qc[m] to the control end of the switch Wc[m], and generates the coupling state designation signal Qs[m] that is at a low level in the control periods TT1 to TT5 and outputs the coupling state designation signal Qs[m] to the control end of the switch Ws[m]. Therefore, the switch Wc[m] is controlled to be non-conductive in the control periods TT1 to TT5, and the switch Ws[m] is controlled to be non-conductive in the control periods TT1 to TT5. At this time, the supply drive signal Vin[m] corresponding to the drive signal Com is not supplied to the piezoelectric element PZ[m] of the ejecting section D[m] that is not an inspection target. Therefore, residual vibration is not generated in the ejecting section D[m] that is not an inspection target, and in this case, even when a potential of the upper electrode Zu[m] of the piezoelectric element PZ[m] included in the ejecting section D[m] that is not an inspection target is changed, a signal according to the change in the potential is not supplied to the wiring Ls. Therefore, a determination of the state of the ejecting section D[m] is not performed.

Further, when the individual designation signal Sd[m]=[1, 0, 1] is input to the coupling state designation circuit 310, the coupling state designation circuit 310 generates the coupling state designation signal Qc[m] that is at a high level in the control periods TT1, TT2, and TT5 and is at a low level in the control periods TT3 and TT4 and outputs the coupling state designation signal Qc[m] to the control end of the switch Wc[m], and generates the coupling state designation signal Qs[m] that is at a high level in the control periods TT2 to TT4 and is at a low level in the control periods TT1 and TT5 and outputs the coupling state designation signal Qs[m] to the control end of the switch Ws[m]. Therefore, the switch Wc[m] is controlled to be conductive in the control periods TT1, TT2, and TT5 and is controlled to be non-conductive in the control periods TT3 and TT4, and the switch Ws[m] is controlled to be conductive in the control periods TT2 to TT4 and is controlled to be non-conductive in the control periods TT1 and TT5.

FIG. 12 is a diagram illustrating an example of a relationship between the individual designation signal Sd[m] and the coupling state designation signals Qf, Q1, and Q2 in the period in which the determination process is being executed. Here, in the period in which the determination process is being executed, the coupling state designation circuit 310 outputs the coupling state designation signals Qf, Q1, and Q2 having the same logic level in each of the control periods TT1 to TT5 when the individual designation signal Sd[m]=[1, 0, 0] is input and when the individual designation signal Sd[m]=[1, 0, 1] is input. Therefore, in FIG. 12, the individual designation signal Sd[m]=[1, 0, 0] and the individual designation signal Sd[m]=[1, 0, 1] are collectively illustrated as the individual designation signal Sd[m]=[1, 0, *].

As illustrated in FIG. 12, when the individual designation signal Sd[m]=[1, 0, *] is input to the coupling state designation circuit 310, the coupling state designation circuit 310 generates the coupling state designation signal Qf that is at a high level in the control periods TT2 to TT4 and is at a low level in the control periods TT1 and TT5 and outputs the coupling state designation signal Qf to the control end of the switch Wf, generates the coupling state designation signal Q1 that is at a high level in the control periods TT1, TT2, TT4, and TT5 and is at a low level in the control period TT3 and outputs the coupling state designation signal Q1 to the control end of the switch W1, and generates the coupling state designation signal Q2 that is at a high level in the control period TT3 and is at a low level in the control periods TT1, TT2, TT4, and TT5 and outputs the coupling state designation signal Q2 to the control end of the switch W2. Therefore, the switch Wf is controlled to be conductive in the control periods TT2 to TT4 and controlled to be non-conductive in the control periods TT1 and TT5, the switch W1 is controlled to be conductive in the control periods TT1, TT2, TT4, and TT5 and controlled to be non-conductive in the control period TT3, and the switch W2 is controlled to be conductive in the control period TT3 and controlled to be non-conductive in the control periods TT1, TT2, TT4, and TT5.

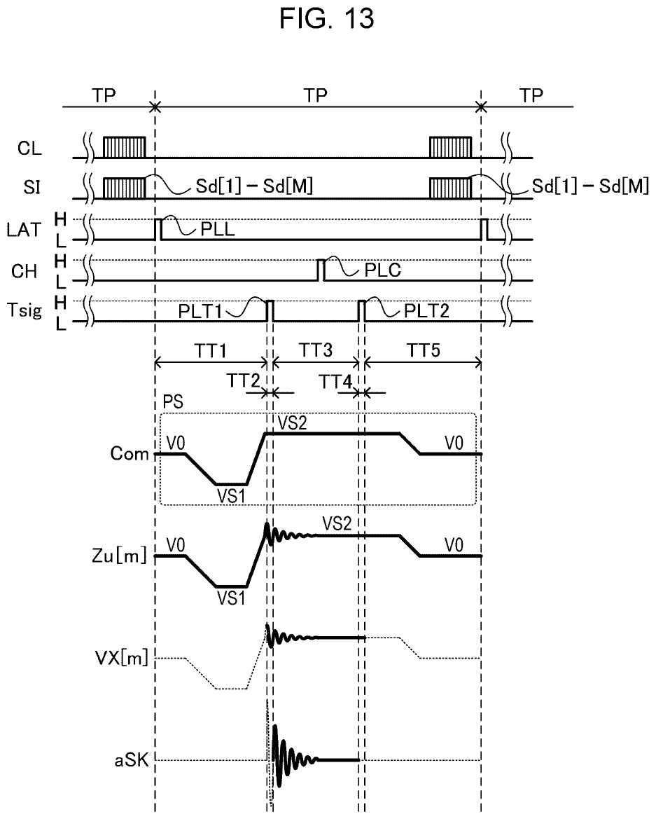

Here, an operation of the liquid ejecting apparatus 1 when the individual designation signal Sd[m]=[1, 0, 1] is input to the coupling state designation circuit 310 will be described as an example of an acquisition operation in which the detection circuit 33 acquires the detection potential signal VX based on a signal according to residual vibration generated in the ejecting section D[m] as an inspection target. FIG. 13 is a diagram describing an example of an acquisition operation of the detection potential signal VX based on the signal according to the residual vibration generated in the ejecting section D[m] as an inspection target.

As illustrated in FIG. 13, for each unit period TP in the period in which the state determination process is being executed, the coupling state designation circuit 310 is supplied with the drive signal Com including the drive waveform PS in which the voltage value starts at the reference potential V0, changes to the potential VS1 having a potential lower than the reference potential V0, and is at the potential VS2 having a potential higher than the reference potential V0 in the control period TT1, maintains the potential VS2 in the control periods TT2 to TT4, and ends at the reference potential V0 in the control period TT5.

Then, in the period in which the state determination process is being executed, the control unit 2 outputs the individual designation signal Sd[m]=[1, 0, 1] corresponding to the ejecting section D[m] as an inspection target to the coupling state designation circuit 310. At this time, the ejecting sections D[1] to D[m−1] and D[m+1] to D[M] are not the inspection targets. That is, the control unit 2 outputs the individual designation signals Sd[1] to Sd[m−1], and Sd[m+1] to Sd[M]=[1, 0, 0] to the coupling state designation circuit 310.

When the print data signal SI including the individual designation signal Sd[m]=[1, 0, 1] and the individual designation signals Sd[1] to Sd[m−1], Sd[m+1] to Sd[M]=[1, 0, 0] is input to the coupling state designation circuit 310, the switch Wc[m] is controlled to be conductive and the switches Wc[1] to Wc[m−1] and Wc[m+1] to Wc[M] are controlled to be non-conductive in the control periods TT1 and TT2. Therefore, in the control periods TT1 and TT2, the upper electrode Zu[m] is supplied with the supply drive signal Vin[m] in which a voltage value starts with the reference potential V0 and changes to the potential VS1 having a potential lower than the reference potential V0, and then is at the potential VS2 having a potential higher than the reference potential V0 and maintains the potential VS2, and the reference potential V0 is held at the upper electrodes Zu[1] to Zu[m−1] and Zu[m+1] to Zu[M]. At this time, in the ejecting section D[m] as an inspection target, residual vibration is generated at a time at which a voltage value of the supply drive signal Vin[m] supplied is constant at the potential VS2. Then, the piezoelectric body Zm [m] is deformed according to the residual vibration generated in the ejecting section D[m] as an inspection target, and an electromotive force corresponding to the deformation of the piezoelectric body Zm [m] is generated in the upper electrode Zu[m]. That is, a signal according to the residual vibration generated in the ejecting section D[m] as an inspection target is generated in the upper electrode Zu[m] of the piezoelectric element PZ[m] included in the ejecting section D[m] as an inspection target. In other words, the ejecting section D[m] includes the piezoelectric element PZ[m] that outputs a signal according to the electromotive force according to the residual vibration.

In the control period TT2, the switch Ws[m] is controlled to be conductive, the switches Ws[1] to Ws[m−1] and Ws[m+1] to Ws[M] are controlled to be non-conductive, and the switch Wf is controlled to be conductive. Therefore, the signal according to the residual vibration generated in the ejecting section D[m] as an inspection target propagates through the wiring Ls as the detection potential signal VX. At this time, the switch W1 is controlled to be conductive, and the switch W2 is controlled to be non-conductive. Therefore, in the control period TT2, the waveform shaping circuit 330 included in the detection circuit 33 does not acquire the detection potential signal VX propagating through the wiring Ls, and thus, does not output the detection signal aSK corresponding to the detection potential signal VX.

In the control period TT3, the switch W1 is controlled to be non-conductive and the switch W2 is controlled to be conductive. Therefore, the waveform shaping circuit 330 included in the detection circuit 33 acquires the detection potential signal VX that is the signal according to the residual vibration generated in the ejecting section D[m] as an inspection target and propagates through the wiring Ls, shapes a signal waveform of the acquired detection potential signal VX, and outputs the shaped signal waveform as the detection signal aSK. The detection signal aSK output by the waveform shaping circuit 330 is converted into a digital signal in the AD conversion circuit 331, and then is input to the determination unit 8 as the detection signal SK.

The determination unit 8 calculates waveform information such as an amplitude, a period, and a frequency of the residual vibration generated in the ejecting section D[m] as an inspection target based on the input detection signal SK, which is waveform information such as an amplitude, a period, and a frequency of the detection potential signal VX. Then, the determination unit 8 determines a state of the ejecting section D[m] as an inspection target based on the calculated waveform information, and outputs a determination result as the ejection state determination information JH to the control unit 2.

In the subsequent control period TT4, the switch W1 is controlled to be conductive and the switch W2 is controlled to be non-conductive, so that the waveform shaping circuit 330 stops acquiring the detection potential signal VX propagating through the wiring Ls and outputting the detection signal aSK. In the control period TT5, the switch Wc[m] is controlled to be conductive and the switch Ws[m] is controlled to be non-conductive. Therefore, the supply of the signal generated in the upper electrode Zu[m] to the wiring Ls is stopped, and the supply drive signal Vin[m] of the reference potential V0 is supplied to the upper electrode Zu[m] of the piezoelectric element PZ[m] included in the ejecting section D[m] as an inspection target. Therefore, a potential of the upper electrode Zu[m] of the piezoelectric element PZ[m] included in the ejecting section D[m] as an inspection target is controlled to the reference potential V0.

Here, as illustrated in FIG. 5, in a period in which the switches Ws[1] to Ws[M] are controlled to be non-conductive and the switch Wf is controlled to be non-conductive, a voltage value of the wiring Ls is ideally held constant at the potential VS2, which is a potential of a signal propagating through the wiring Ls immediately before the switches Ws[1] to Ws[M] and Wf are controlled to be non-conductive, and is a voltage value of the drive signal Com when acquiring the signal according to the residual vibration. Meanwhile, even in the period in which the switches Ws[1] to Ws[M] are controlled to be non-conductive and the switch Wf is controlled to be non-conductive, the voltage value of the wiring Ls may change due to an influence of a leakage current flowing into the wiring Ls or flowing out from the wiring Ls. Therefore, a potential difference may occur between the upper electrode Zu[m] of the piezoelectric element PZ[m] included in the ejecting section D[m] as an inspection target and the wiring Ls during the period in which the switches Ws[1] to Ws[M] are controlled to be non-conductive and the switch Wf is controlled to be non-conductive, such as a period in which the ejection process is being executed.

When the switch Ws[m] is controlled to be conductive in a state in which the potential difference occurs between the upper electrode Zu[m] of the piezoelectric element PZ[m] included in the ejecting section D[m] as an inspection target and the wiring Ls, a signal obtained by superimposing a signal according to the potential difference on the signal according to the residual vibration generated in the ejecting section D[m] as an inspection target is propagated through the wiring Ls as the detection potential signal VX. At this time, an amplitude of the signal according to the residual vibration generated in the ejecting section D[m] as an inspection target is approximately several tens of mV, whereas an amplitude of the signal generated by the potential difference between the upper electrode Zu[m] of the piezoelectric element PZ[m] included in the ejecting section D[m] as an inspection target and the wiring Ls reaches several V in some cases. When such a signal is superimposed on the signal according to the residual vibration generated in the ejecting section D[m] as an inspection target, signal accuracy of the detection potential signal VX propagating through the wiring Ls is significantly reduced. As a result, calculation accuracy of the waveform information such as the amplitude, the period, and the frequency of the residual vibration generated in the ejecting section D[m] as an inspection target is significantly reduced, and determination accuracy of the state of the ejecting section D[m] as an inspection target in the determination unit 8 is significantly reduced.

On the other hand, in the liquid ejecting apparatus 1 of the present embodiment, immediately before the determination process is executed, a determination preparation process is executed such that the voltage value of the wiring Ls is controlled to have the potential VS2 which is an intermediate potential of the signal according to the residual vibration generated in the ejecting section D[m] as an inspection target and which is a voltage value of the drive signal Com when the residual vibration is generated in the ejecting section D[m] as an inspection target. Therefore, when the determination process is executed, the potential difference generated between the upper electrode Zu[m] of the piezoelectric element PZ[m] included in the ejecting section D[m] as an inspection target and the wiring Ls can be reduced, the accuracy of the detection potential signal VX propagating through the wiring Ls can be improved, and the calculation accuracy of the waveform information such as the amplitude, the period, and the frequency of the residual vibration generated in the ejecting section D[m] as an inspection target in the determination unit 8 can be improved. As a result, the determination accuracy of the state of the ejecting section D[m] as an inspection target in the determination process is improved.

An example of a decoding content of the individual designation signals Sd[1] to Sd[M] executed by the coupling state designation circuit 310 in a period in which the determination preparation process is being executed, in a relationship between the individual designation signals Sd[1] to Sd[M] included in the print data signal SI input to the coupling state designation circuit 310 and the coupling state designation signals Qc[1] to Qc[M], Qs[1] to Qs[M], Qf, Q1, and Q2 output by the coupling state designation circuit 310, in the period in which the determination preparation process is being executed will be described. Here, the drive signal Com input to the coupling state designation circuit 310 during the period in which the determination preparation process is being executed is the same as the drive signal Com input to the coupling state designation circuit 310 during the period in which the determination process is being executed, and the description thereof will be omitted.

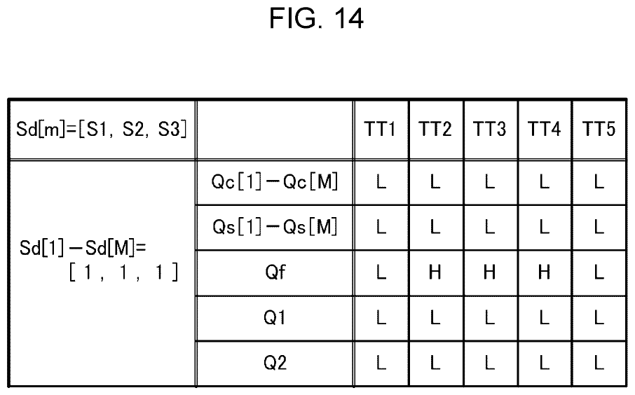

FIG. 14 is a diagram illustrating an example of a relationship between the individual designation signal Sd[m] and the coupling state designation signals Qc[m] and Qs[m] in a period in which a determination preparation process is being executed. As illustrated in FIG. 14, in the period in which the determination preparation process is being executed, the individual designation signals Sd[1] to Sd[M]=[1, 1, 1] are input to the coupling state designation circuit 310. At this time, the coupling state designation circuit 310 outputs the coupling state designation signals Qc[1] to Qc[M], Qs[1] to Qs[M], Q1, and 02 that are at a low level in the control periods TT1 to TT5 and the coupling state designation signal Qf that is at a low level in the control periods TT1 and TT5 and is at a high level in the control periods TT2 to TT4. Therefore, the switches Wc[1] to Wc[M], Ws[1] to Ws[M], W1, and W2 are controlled to be non-conductive in the control periods TT1 to TT5, the switch Wf is controlled to be non-conductive in the control periods TT1 and TT5, and is controlled to be conductive in the control periods TT2 to TT4. That is, in the control periods TT2 to TT4 within the period in which the determination preparation process is being executed, the wiring Ls and the wiring Lc are electrically coupled via the resistor Rf.

As described above, in the period in which the determination preparation process is being executed, the drive signal output unit 4 outputs the drive signal Com having a constant voltage value at the potential VS2 in the control periods TT2 to TT4. Therefore, in the control periods TT2 to TT4 within the period in which the determination preparation process is being executed, the switch Wf is controlled to be conductive, and thus a signal having a constant voltage value at the potential VS2 is supplied to the wiring Ls via the resistor Rf. Therefore, the voltage value of the wiring Ls is controlled to be the potential VS2 during the period in which the determination preparation process is being executed. As a result, in the period in which the determination process after the determination preparation process is being executed, a potential difference between the upper electrode Zu[m] of the piezoelectric element PZ[m] included in the ejecting section D[m] as an inspection target and the wiring Ls can be reduced. As a result, in the period in which the determination process is being executed, accuracy of the detection potential signal VX propagating through the wiring Ls is improved, and determination accuracy of the state of the ejecting section D[m] as an inspection target in the determination unit 8 is improved.

Here, when the voltage value of the wiring Ls is controlled to be constant at the potential VS2, a time required for the control is defined by a parasitic capacitance of the wiring Ls and a resistance value of the resistor Rf, and may be at most several hundred μs. On the other hand, a time from the control period TT2 to the control period TT4 within the period in which the state determination process is being executed is approximately several tens of μs, and the voltage value of the wiring Ls may not be controlled to be constant at the potential VS2 by performing the determination preparation process only once. Therefore, in the liquid ejecting apparatus 1 of the present embodiment, the determination preparation process is repeatedly executed a plurality of times immediately before the execution of the determination process during the period in which the state determination process is being executed. Therefore, a sufficient time for controlling the voltage value of the wiring Ls to be constant at the potential VS2 can be secured, and the voltage value of the wiring Ls can be controlled to be the potential VS2 in the period in which the determination process is being executed.

### 4. CORRECTION VALUE ACQUISITION PROCESS

As described above, in the liquid ejecting apparatus 1 of the present embodiment, by executing the determination preparation process immediately before the determination process, the potential difference between the upper electrode Zu[m] of the piezoelectric element PZ[m] included in the ejecting section D[m] as an inspection target and the wiring Ls in the period in which the determination process is executed can be reduced, the accuracy of the detection potential signal VX acquired by the detection circuit 33 in the period in which the determination process is executed is improved, and the determination accuracy of the state of the ejecting section D[m] as an inspection target in the determination unit 8 is improved.

On the other hand, a leakage current flowing into the wiring Ls or flowing out of the wiring Ls is also generated during the period in which the determination process is being executed. Therefore, within the period in which the determination process described above is executed, the voltage value of the wiring Ls changes slightly due to the leakage current even in the control periods TT1, TT5, or the like in which the switches Ws[1] to Ws[M] are controlled to be non-conductive and the switch Wf is controlled to be non-conductive. In the liquid ejecting apparatus 1 of the present embodiment, the storage unit 9 stores correction value information in response to the change in the voltage value generated in the wiring Ls due to the leakage current. The determination unit 8 corrects the detection signal SK by using the correction value information. Therefore, the possibility that the determination accuracy of the state of the ejecting section D[m] as an inspection target in the determination unit 8 is lowered due to the change in the voltage value of the wiring Ls generated during the period in which the determination process is executed is reduced.

Here, a correction value acquisition process of acquiring correction value information to be used for correction on the detection signal SK by the determination unit 8, which is correction value information stored in the storage unit 9, will be described. Here, in the correction value acquisition process of acquiring the correction value information, the same signal as the signal in the state determination process described above is input to the supply circuit 31, except that a signal waveform of the drive signal Com is different. That is, the supply circuit 31 executes the same operation as the state determination process described above, in the correction value acquisition process of acquiring the correction value information. Therefore, the correction value acquisition process includes an acquisition process corresponding to the determination process described above and an acquisition preparation process corresponding to the determination preparation process described above and executed immediately before the acquisition process.

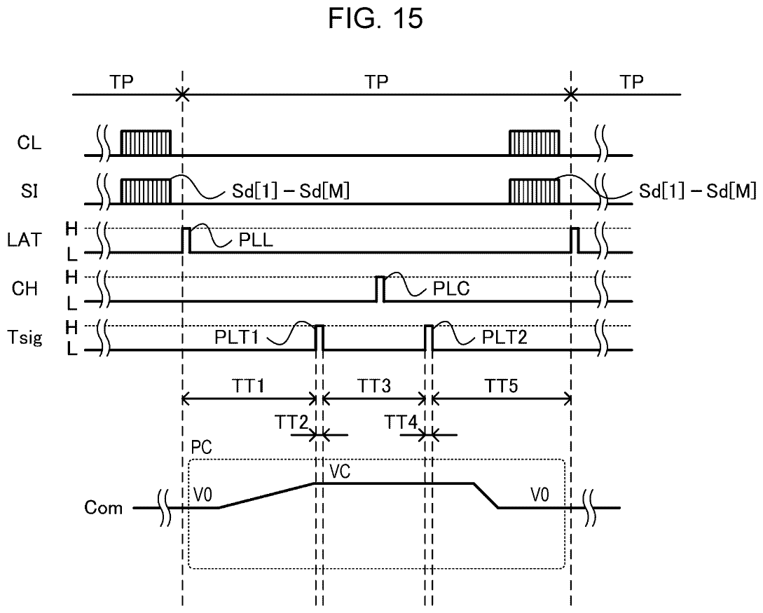

FIG. 15 is a diagram describing an example of various signals input to the supply circuit 31 of the head unit 3 during a period in which a correction value acquisition process is being executed.

The control unit 2 generates the drive waveform designation signal dCom that defines a signal waveform of the drive signal Com output by the drive signal output unit 4 in the period in which the correction value acquisition process is being executed, and outputs the drive waveform designation signal dCom to the drive signal output unit 4. Therefore, the drive signal output unit 4 generates the drive signal Com including a drive waveform PC for each unit period TP as illustrated in FIG. 15, in accordance with the input drive waveform designation signal dCom, and supplies the drive signal Com to the head unit 3.

The drive waveform PC is a signal waveform that starts with a voltage value at the reference potential V0 and is at the potential VC having a potential higher than the reference potential V0 in the control period TT1, maintains the potential VC in the control periods TT2, TT3, and TT4, and ends with the reference potential V0 in the control period TT5, and is a signal waveform in which a change amount in the voltage value per short time in the control period TT1 is smaller than the drive waveforms PP1, PP2, and PS. That is, the change amount in the voltage value of the drive waveform PC per unit time is smaller than the change amount in the voltage value of the drive waveform PS per unit time. When the drive waveform PC is supplied to the piezoelectric element PZ[m] of the ejecting section D[m], the piezoelectric element PZ[m] is driven such that an ink is not ejected from the nozzle N[m] of the ejecting section D[m] and residual vibration is not generated in the ejecting section D[m]. That is, the drive waveform PC is a signal waveform which drives the piezoelectric element PZ[m] such that the ink is not ejected from the nozzle N[m] of the ejecting section D[m] and with which the residual vibration is not generated in the ejecting section D[m]. When the drive waveform PC is supplied, the piezoelectric element PZ[m] is driven such that the residual vibration is not generated in the ejecting section D[m].

First, an acquisition preparation process in a correction value acquisition process will be described. The acquisition preparation process is a process for controlling a voltage value of the wiring Ls in a period in which an acquisition process is executed, to the potential VC which is a voltage value of the drive signal Com in the control periods TT2 to TT4 within a period in which the correction value acquisition process is being executed. In a period in which the acquisition preparation process is executed, the clock signal CL, the print data signal SI, the latch signal LAT, the change signal CH, and the period designation signal Tsig, which are the same as the signals in a period in which the determination preparation process described above is executed are input to the supply circuit 31.

That is, in the period in which the acquisition preparation process is being executed, the print data signal SI including the individual designation signals Sd[1] to Sd[M]=[1, 1, 1] is input to the coupling state designation circuit 310 included in the supply circuit 31. Therefore, the coupling state designation circuit 310 outputs the coupling state designation signals Qc[1] to Qc[M], Qs[1] to Qs[M], Q1, and Q2, which are at a low level in the control periods TT1 to TT5, and the coupling state designation signal Qf, which is at a low level in the control periods TT1 and TT5 and is at a high level in the control periods TT2 to TT4, as illustrated in FIG. 14. Therefore, the switches Wc[1] to Wc[M], Ws[1] to Ws[M], W1, and W2 are controlled to be non-conductive in the control periods TT1 to TT5, the switch Wf is controlled to be non-conductive in the control periods TT1 and TT5, and is controlled to be conductive in the control periods TT2 to TT4. As a result, the wiring Ls and the wiring Lc are electrically coupled to each other via the resistor Rf in the control periods TT2 to TT4 within the period in which the acquisition preparation process is being executed.

As illustrated in FIG. 15, in the period in which the acquisition preparation process is being executed, the drive signal output unit 4 outputs the drive signal Com in which the voltage value is constant at the potential VC in the control periods TT2 to TT4. Therefore, in the control periods TT2 to TT4 within the period in which the acquisition preparation process is being executed, the switch Wf is controlled to be conductive, and thus a signal having a constant voltage value at the potential VC is supplied to the wiring Ls via the resistor Rf. Therefore, the voltage value of the wiring Ls is controlled to be the potential VC in the period in which the acquisition preparation process is executed. At this time, the acquisition preparation process may be repeatedly executed a plurality of times immediately before the execution of the acquisition process within the period in which the correction value acquisition process is being executed, in the same manner as in the determination preparation process described above. Therefore, a sufficient time for controlling the voltage value of the wiring Ls to be constant at the potential VC can be secured, and the voltage value of the wiring Ls in the period in which the acquisition process is executed can be controlled to be the potential VC.

Next, the acquisition process in the correction value acquisition process will be described. The acquisition process is a process executed after the acquisition preparation process described above, and is a process of acquiring correction value information which is stored in the storage unit 9 and to be used for correcting the detection signal SK by the determination unit 8. In a period in which the acquisition process is being executed, the clock signal CL, the print data signal SI, the latch signal LAT, the change signal CH, and the period designation signal Tsig, which are the same as the signals in a period in which the determination process described above is being executed are input to the supply circuit 31.

In the period in which the liquid ejecting apparatus 1 executes the acquisition process, the print data signal SI including the individual designation signal Sd[m]=[1, 0, 1] corresponding to any ejecting section D[m] and the individual designation signals Sd[1] to Sd[m−1], Sd[m+1] to Sd[M]=[1, 0, 0] corresponding to the ejecting sections D[1] to D[m−1], D[m+1] to D[M] other than the ejecting section D[m] is input to the coupling state designation circuit 310 included in the supply circuit 31.

Based on the input individual designation signals Sd[1] to Sd[m−1], Sd[m+1] to Sd[M]=[1, 0, 0] and the decoding contents illustrated in FIG. 11, the coupling state designation circuit 310 generates the coupling state designation signals Qc[1] to Qc[m−1], Qc[m+1] to Qc[M] that are at a low level in the control periods TT1 to TT5 and outputs the generated signals to the control ends of the corresponding switches Wc[1] to Wc[m−1], Wc[m+1] to Wc[M], and generates the coupling state designation signals Qs[1] to Qs[m−1], Qs[m+1] to Qs[M] that are at a low level in the control periods TT1 to TT5 and outputs the generated signals to the control ends of the corresponding switches Ws[1] to Ws[m−1], Ws[m+1] to Ws[M]. Therefore, each of the switches Wc[1] to Wc[m−1] and Wc[m+1] to Wc[M] is controlled to be non-conductive in the control periods TT1 to TT5, and each of the switches Ws[1] to Ws[m−1] and Ws[m+1] to Ws[M] is controlled to be non-conductive in the control periods TT1 to TT5.

In addition, based on the input individual designation signal Sd[m]=[1, 0, 1] and the decoding contents illustrated in FIG. 11, the coupling state designation circuit 310 generates the coupling state designation signal Qc[m] that is at a high level in the control periods TT1, TT2, and TT5 and is at a low level in the control periods TT3 and TT4 and outputs the coupling state designation signal Qc[m] to the control end of the switch Wc[m], and generates the coupling state designation signal Qs[m] that is at a high level in the control periods TT2 to TT4 and is at a low level in the control periods TT1 and TT5 and outputs the coupling state designation signal Qs[m] to the control end of the switch Ws[m]. Therefore, the switch Wc[m] is controlled to be conductive in the control periods TT1, TT2, and TT5 and is controlled to be non-conductive in the control periods TT3 and TT4, and the switch Ws[m] is controlled to be conductive in the control periods TT2 to TT4 and is controlled to be non-conductive in the control periods TT1 and TT5.

In addition, based on the input individual designation signals Sd[1] to Sd[M]=[1, 0, *] and the decoding contents illustrated in FIG. 12, the coupling state designation circuit 310 generates the coupling state designation signal Qf that is at a high level in the control periods TT2 to TT4 and is at a low level in the control periods TT1 and TT5 and outputs the coupling state designation signal Qf to the control end of the switch Wf, generates the coupling state designation signal Q1 that is at a high level in the control periods TT1, TT2, TT4, and TT5 and is at a low level in the control period TT3 and outputs the coupling state designation signal Q1 to the control end of the switch W1, and generates the coupling state designation signal Q2 that is at a high level in the control period TT3 and is at a low level in the control periods TT1, TT2, TT4, and TT5 and outputs the coupling state designation signal Q2 to the control end of the switch W2. Therefore, the switch Wf is controlled to be conductive in the control periods TT2 to TT4 and controlled to be non-conductive in the control periods TT1 and TT5, the switch W1 is controlled to be conductive in the control periods TT1, TT2, TT4, and TT5 and controlled to be non-conductive in the control period TT3, and the switch W2 is controlled to be conductive in the control period TT3 and controlled to be non-conductive in the control periods TT1, TT2, TT4, and TT5.

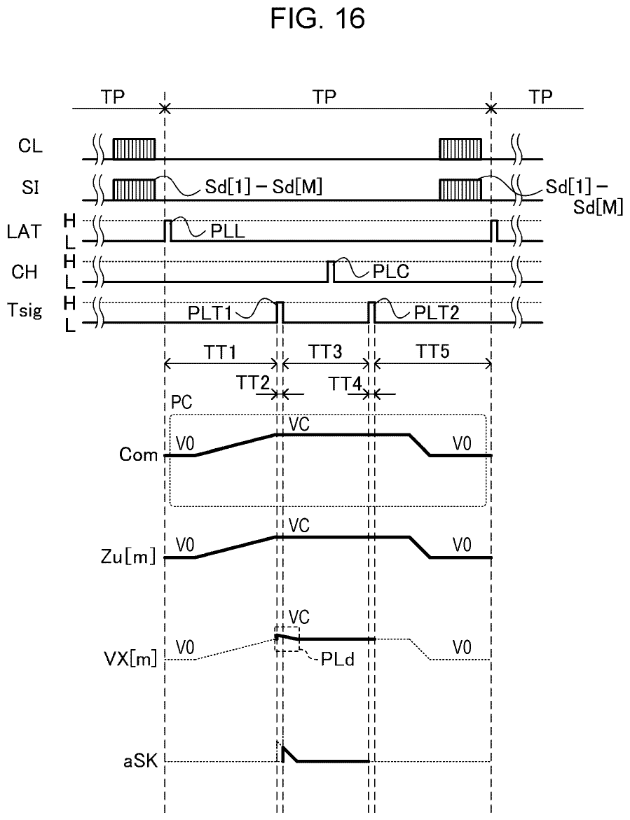

Here, an operation of the liquid ejecting apparatus 1 in a period in which an acquisition process is being executed will be described. FIG. 16 is a diagram describing an example of the operation of the liquid ejecting apparatus 1 during the period in which the acquisition process is being executed. As illustrated in FIG. 16, for each unit period TP in the period in which the acquisition process is being executed, the coupling state designation circuit 310 is supplied with the drive signal Com including the drive waveform PC in which a voltage value starts at the reference potential V0 and is at the potential VC having a potential higher than the reference potential V0 in the control period TT1, maintains the potential VC in the control periods TT2, TT3, and TT4, and ends at the reference potential V0 in the control period TT5.

In addition, in the period in which the acquisition process is executed, the control unit 2 outputs the print data signal SI including the individual designation signal Sd[m]=[1, 0, 1] and the individual designation signals Sd[1] to Sd[m−1], Sd[m+1] to Sd[M]=[1, 0, 0]. When the print data signal SI including the individual designation signal Sd[m]=[1, 0, 1] and the individual designation signals Sd[1] to Sd[m−1], Sd[m+1] to Sd[M]=[1, 0, 0] is input to the coupling state designation circuit 310, the switch Wc[m] is controlled to be conductive and the switches Wc[1] to Wc[m−1] and Wc[m+1] to Wc[M] are controlled to be non-conductive in the control periods TT1 and TT2. Therefore, in the control periods TT1 and TT2, the upper electrode Zu[m] is supplied with the supply drive signal Vin[m] which starts with a voltage value at the reference potential V0 and is at the potential VC having a potential higher than the reference potential V0, and maintains the potential VC, and the upper electrodes Zu[1] to Zu[m−1] and Zu[m+1] to Zu[M] is continuously supplied with the reference potential V0. At this time, no residual vibration is generated in the ejecting section D[m] to which the supply drive signal Vin[m] is supplied and the supply drive signals Vin[1] to Vin[m−1] and Vin[m+1] to Vin[M] are not supplied, so that no residual vibration is generated in the ejecting sections D[1] to D[m−1] and D[m+1] to D[M].

Then, in the control period TT2, the switches Ws[m] and Wf are controlled to be conductive. At this time, the switches Ws[1] to Ws[m−1] and Ws[m+1] to Ws[M] continue to be non-conductive. When a voltage value of the wiring Ls changes due to a leakage current flowing into the wiring Ls or flowing out from the wiring Ls when the switch Ws[m] is controlled to be conductive, a signal in which a differential pulse PLd corresponding to a potential difference between the voltage value of the wiring Ls and a potential of the upper electrode Zu[m] is superimposed on the potential VC, which is a potential of the upper electrode Zu[m], propagates as the detection potential signal VX to the wiring Ls. At this time, the switch W1 is controlled to be conductive, and the switch W2 is controlled to be non-conductive. Therefore, in the control period TT2, the waveform shaping circuit 330 included in the detection circuit 33 does not acquire the detection potential signal VX propagating through the wiring Ls, and does not output the detection signal aSK corresponding to the detection potential signal VX.

In the control period TT3, the switch W1 is controlled to be non-conductive and the switch W2 is controlled to be conductive. Thus, the waveform shaping circuit 330 included in the detection circuit 33 acquires the detection potential signal VX propagating through the wiring Ls, shapes a signal waveform of the acquired detection potential signal VX, and outputs the shaped signal waveform as the detection signal aSK. The detection signal aSK output by the waveform shaping circuit 330 is converted into a digital signal in the AD conversion circuit 331, and then is output to the determination unit 8 as the detection signal SK. The determination unit 8 stores the input detection signal SK in the storage unit 9 as correction value information. That is, the determination unit 8 stores a signal according to the differential pulse PLd in the storage unit 9 as the correction value information. In other words, the storage unit 9 stores the detection signal SK output by the detection circuit 33 as the correction value information, in accordance with the detection potential signal VX propagating through the wiring Ls and including the signal output from the ejecting section D after the drive waveform PC is supplied to the piezoelectric element PZ[m] as the supply drive signal Vin[m] based on the drive signal Com.

In the subsequent control period TT4, the switch W1 is controlled to be conductive and the switch W2 is controlled to be non-conductive, so that the waveform shaping circuit 330 stops acquiring the detection potential signal VX propagating through the wiring Ls and outputting the detection signal aSK. In the control period TT5, the switch Wc[m] is controlled to be conductive and the switch Ws[m] is controlled to be non-conductive. Therefore, the supply of the signal generated in the upper electrode Zu[m] to the wiring Ls is stopped, and the supply drive signal Vin[m] of the reference potential V0 is supplied to the upper electrode Zu[m] of the piezoelectric element PZ[m] included in the ejecting section D[m] as an inspection target. Therefore, a potential of the upper electrode Zu[m] of the piezoelectric element PZ[m] included in the ejecting section D[m] as an inspection target is controlled to the reference potential V0.

Here, the differential pulse PLd which is a base of the correction value information stored in the storage unit 9 is a signal according to the potential difference generated between the voltage value of the wiring Ls and the potential of the upper electrode Zu[m] when the switch Ws[m] is controlled to be conductive in a period in which the acquisition process is being executed, and is a signal according to the voltage value of the wiring Ls changed by the leakage current flowing into or flowing out from the wiring Ls, in the period in which the acquisition process is being executed, in a period in which the switches Ws[1] to Ws[M] and the switch Wf are controlled to be non-conductive.

In the determination process executed after the determination preparation process is executed, the voltage value of the wiring Ls changes due to the leakage current flowing into or flowing out from the wiring Ls, in the period in which the switches Ws[1] to Ws[M] and the switch Wf are controlled to be non-conductive. Therefore, in the determination process, the detection potential signal VX propagating through the wiring Ls includes a signal according to residual vibration generated in the ejecting section D[m] as an inspection target and a signal according to a potential difference generated between the voltage value of the wiring Ls immediately before the switch Ws[m] is controlled to be conductive and the potential of the upper electrode Zu[m].

Here, as described above, in the correction value acquisition process and the state determination process, the same signal is input to the supply circuit 31 of the head unit 3, except that the signal waveform of the drive signal Com is different. Therefore, a length of each of the control periods TT1 to TT5 defined by the latch signal LAT and the period designation signal Tsig in the unit period TP in the period in which the correction value acquisition process is being executed and a length of each of the control periods TT1 to TT5 defined by the latch signal LAT and the period designation signal Tsig in the unit period TP in the period in which the state determination process is being executed are substantially equal. A length of a period in which the switch Ws[1] to Ws[M] and the switch Wf are controlled to be non-conductive in the unit period TP in the period in which the correction value acquisition process is being executed and a length of a period in which the switch Ws[1] to Ws[M] and the switch Wf are controlled to be non-conductive in the unit period TP in the period in which the state determination process is being executed are substantially equal. Therefore, the amount of leakage current flowing into the wiring Ls or flowing out of the wiring Ls is substantially equal to each other in the period in which the correction value acquisition process is being executed and the period in which the state determination process is executed. The change amount in the voltage value of the wiring Ls is substantially equal to each other in the period in which the correction value acquisition process is being executed and the period in which the state determination process is executed.

Therefore, in the period in which the correction value acquisition process is executed, the differential pulse PLd propagating through the wiring Ls is substantially equal to a signal generated according to a potential difference between the voltage value of the wiring Ls immediately before the switch Ws[m] included in the detection potential signal VX propagating through the wiring Ls is controlled to be conductive and the potential of the upper electrode Zu[m], in the period in which the determination process is executed.

In the liquid ejecting apparatus 1 of the present embodiment, in the correction value acquisition process, the signal according to the differential pulse PLd as described above is stored in the storage unit 9 as correction value information, and in the state determination process, the determination unit 8 corrects the detection signal SK by using the correction value information for the signal according to the differential pulse PLd stored in the storage unit 9. Therefore, determination accuracy of a state of the ejecting section D[m] in the determination unit 8 can be further improved.

That is, in the liquid ejecting apparatus 1 of the present embodiment, the determination unit 8 determines the state of the ejecting section D[m], based on a signal obtained by correcting the detection signal SK output by the detection circuit 33, in accordance with the detection potential signal VX including a signal output from the ejecting section D and propagating through the wiring Ls after the drive waveform PS as the supply drive signal Vin[m] based on the drive signal Com is supplied to the piezoelectric element PZ[m], by using the correction value information stored in the storage unit 9. Therefore, during the period in which the determination process is being executed, an influence of the leakage current flowing into the wiring Ls or flowing out from the wiring Ls is reduced, and as a result, the determination accuracy of the state of the ejecting section D[m] in the determination unit 8 can be further improved.

### 5. EJECTION STATE DETERMINATION METHOD IN LIQUID EJECTING APPARATUS

An ejection state determination method in the liquid ejecting apparatus 1 configured as described above will be described. The ejection state determination method of the liquid ejecting apparatus 1 of the present embodiment includes a correction value acquisition method of acquiring correction value information to be used for correction of the input detection signal SK and storing the correction value information in the storage unit 9, and an ejection determination method of determining a state of the ejecting section D in a period in which an image corresponding to the image data Img is formed on a medium, by the determination unit 8. The correction value acquisition method may be executed as a part of a step of the ejection determination method, or may be executed as a step independent of the ejection determination method in a manufacturing step or the like of the liquid ejecting apparatus 1.

### 5.1 Correction Value Acquisition Method

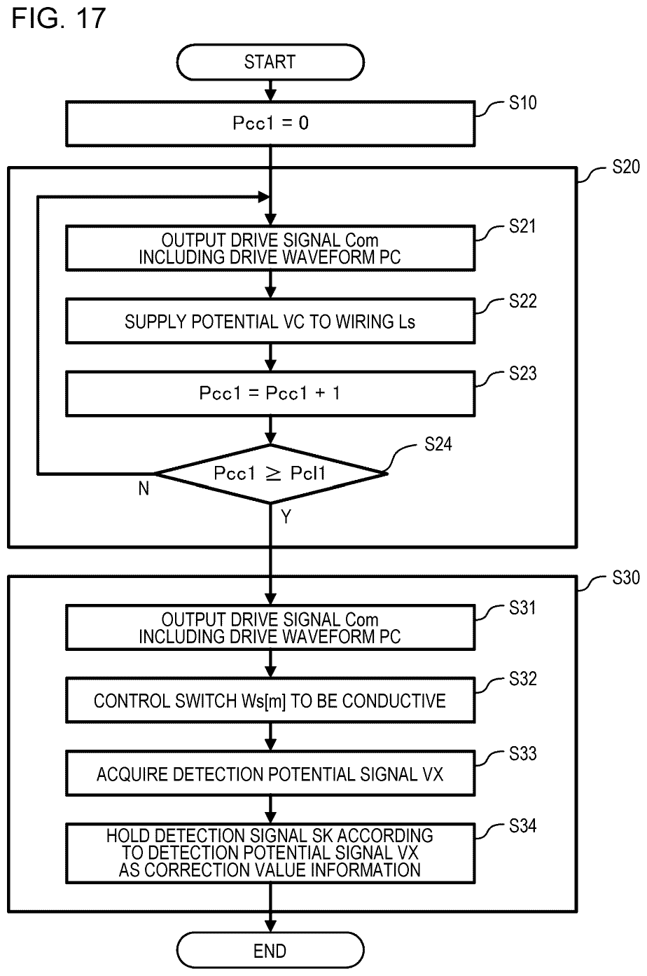

FIG. 17 is a diagram illustrating an example of a correction value acquisition method. As illustrated in FIG. 17, when the correction value acquisition method is started, the control unit 2 sets “0” to a charging count Pcc1 as an initial setting (step S10). After the initial setting is completed, an acquisition preparation step including the acquisition preparation process is executed (step S20).

As illustrated in FIG. 17, in the acquisition preparation step, the drive signal output unit 4 outputs the drive signal Com including the drive waveform PC (step S21). Specifically, in the acquisition preparation step, the control unit 2 generates the drive waveform designation signal dCom corresponding to the drive waveform PC and outputs the drive waveform designation signal dCom to the drive signal output unit 4, and the drive signal output unit 4 outputs the drive signal Com including the drive waveform PC by amplifying a signal waveform defined by the input drive waveform designation signal dCom. Here, as described above, the drive waveform PC is a signal waveform for driving the piezoelectric element PZ[m] such that an ink is not ejected from the ejecting section D[m] and residual vibration is not generated when the drive waveform PC is input to the ejecting section D[m].

In the acquisition preparation step, the control unit 2 generates the print data signal SI for controlling the switch Wf to be conductive in the control periods TT2 to TT4 in which a voltage value of the drive signal Com output by the drive signal output unit 4, that is, a voltage value of the drive waveform PC is constant at the potential VC, and outputs the print data signal SI to the coupling state designation circuit 310. Therefore, the coupling state designation circuit 310 controls the switch Wf to be conductive, in the control periods TT2 to TT4. As a result, in the control periods TT2 to TT4, the wiring Ls and the wiring Lc through which the drive signal Com propagates are electrically coupled to each other, and the potential VC is supplied to the wiring Ls (step S22).

Thereafter, the control unit 2 adds “1” to the charging count Pcc1 (step S23), and determines whether or not the charging count Pcc1 after the addition is equal to or larger than a charging count limit Pcl1 (step S24). When the control unit 2 determines that the charging count Pcc1 is not equal to or larger than the charging count limit Pcl1 (N in step S24), the processes in steps S21 to S23 described above are executed again. That is, in the acquisition preparation step, the processes in steps S21 to S23 are repeatedly executed the number of times defined by the charging count limit Pcl1. On the other hand, when the control unit 2 determines that the charging count Pcc1 is equal to or larger than the charging count limit Pcl1 (N in step S24), the acquisition preparation step is ended.

Here, the charging count limit Pcl1 is defined in accordance with a time required for a voltage value of the wiring Ls to reach the potential VC by a process of supplying the potential VC to the wiring Ls illustrated in step S22. For example, when the maximum time required for the voltage value of the wiring Ls to reach the potential VC is 400 us and a time from the control period TT2 to the control period TT4 in the acquisition preparation step is 40 μs, the charging count limit Pcl1 is set to “10”. Therefore, in the acquisition preparation step, the voltage value of the wiring Ls can be set to the potential VC. The charging count limit Pcl1 may be a fixed value stored in advance by a manufacturer at a manufacturing stage of the liquid ejecting apparatus 1, and may be a value that can be appropriately changed according to a request of a user, an operation situation of the liquid ejecting apparatus 1, and the like at a specification stage of the liquid ejecting apparatus 1.

After the acquisition preparation step is ended, an acquisition step including the acquisition process described above is executed (step S30). That is, the acquisition step of acquiring correction value information and storing the correction value information in the storage unit 9 is executed after the acquisition preparation step of storing a charge in a capacitive component of the detection circuit 33 including the wiring Ls.

In the acquisition step, the drive signal output unit 4 outputs the drive signal Com including the drive waveform PC (step S31). Specifically, in the acquisition step, the control unit 2 outputs the drive waveform designation signal dCom corresponding to the drive waveform PC to the drive signal output unit 4, and the drive signal output unit 4 outputs the drive signal Com including the drive waveform PC by amplifying the signal waveform defined by the input drive waveform designation signal dCom.

In the acquisition step, the control unit 2 generates the print data signal SI for controlling the switch Ws[m] to be conductive in the control periods TT2 to TT4 in which a voltage value of the drive signal Com output by the drive signal output unit 4, that is, a voltage value of the drive waveform PC is constant at the potential VC, and outputs the print data signal SI to the coupling state designation circuit 310. Therefore, the switch Ws[m] is controlled to be conductive, in the control periods TT2 to TT4 (step S32). Therefore, the upper electrode Zu[m] of the piezoelectric element PZ[m] and the wiring Ls are electrically coupled to each other, and the detection potential signal VX corresponding to the potential of the upper electrode Zu[m] of the piezoelectric element PZ[m] propagates through the wiring Ls.

At this time, the detection potential signal VX propagating through the wiring Ls is a signal in which the differential pulse PLd corresponding to a potential difference generated between the upper electrode Zu[m] of the piezoelectric element PZ[m] and the wiring Ls immediately before the switch Ws[m] is controlled to be conductive is superimposed on the potential VC which is a voltage value of the upper electrode Zu[m] of the piezoelectric element PZ[m] in the control period TT2. Thereafter, the switch W1 is controlled to be non-conductive and the switch W2 is controlled to be conductive, in the control period TT3 according to the print data signal SI output by the control unit 2. Therefore, the detection circuit 33 acquires the detection potential signal VX in which the differential pulse PLd is superimposed on the potential VC (step S33). The detection circuit 33 generates the detection signal SK according to the acquired detection potential signal VX, and outputs the detection signal SK to the determination unit 8.

The determination unit 8 stores the detection signal SK according to the input detection potential signal VX as the correction value information in the storage unit 9. That is, the determination unit 8 holds the detection signal SK according to the detection potential signal VX as the correction value information (step S34). Then, the acquisition step is ended by storing the correction value information in the storage unit 9, and the correction value acquisition method is completed by ending the acquisition step.

As described above, the acquisition step included in the correction value acquisition method is a step of acquiring the correction value information for correcting the detection signal SK, and includes step S31 of supplying the drive waveform PC as the supply drive signal Vin[m] based on the drive signal Com to the piezoelectric element PZ[m], step S32 of switching the switch Ws[m] such that the signal according to the residual vibration generated in the ejecting section D[m] propagates through the wiring Ls and is supplied to the detection circuit 33 as the detection potential signal VX after step S31, and step S34 of holding the detection signal SK according to the detection potential signal VX output by the detection circuit 33 as the correction value information after step S32.

### 5.2 Printing Process Method

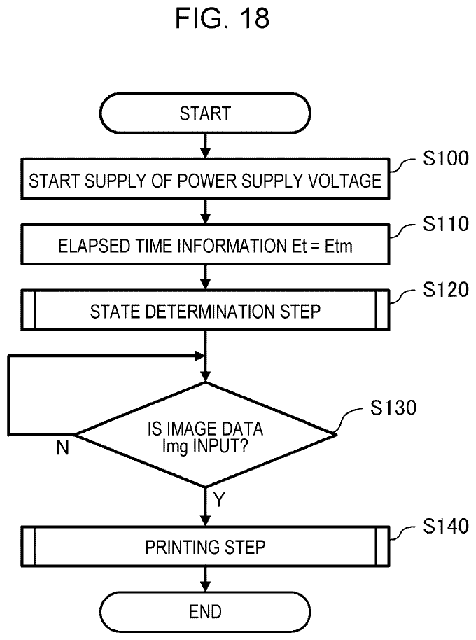

FIG. 18 is a diagram illustrating an example of an ejection determination method. As illustrated in FIG. 18, the ejection determination process is started by supplying a power supply voltage to various configurations of the liquid ejecting apparatus 1 (step S100). Here, the start of the supply of the power supply voltage to the various configurations of the liquid ejecting apparatus 1 is not limited to supply of a commercial power supply voltage to the liquid ejecting apparatus 1 is started, and includes a case where the liquid ejecting apparatus 1 includes a power supply circuit (not illustrated), the power supply circuit generates a power supply voltage having a voltage value corresponding to the various configurations of the liquid ejecting apparatus 1 based on the commercial power supply voltage in a state in which the commercial power supply voltage is supplied to the liquid ejecting apparatus 1, the supply of the power supply voltage generated for the various configurations of the liquid ejecting apparatus 1 is started, and the like.

After the supply of the power supply voltage to the various configurations of the liquid ejecting apparatus 1 is started, the control unit 2 sets an elapsed time information Et to a fixed value Etm as an initial setting (step S110). Here, the fixed value Etm is a value larger than the charging count limit Pcl2 described below, and is, for example, the maximum value of the elapsed time described below that can be measured in the liquid ejecting apparatus 1. Then, after the initial setting described above is completed, the liquid ejecting apparatus 1 shifts to a state determination step (step S120). The state determination step is a step including the state determination process described above, and is a step of determining a state of the ejecting section D that ejects an ink to the medium P. Details of the state determination step will be described below.

When the state determination step in step S120 is ended, the control unit 2 determines whether or not the image data Img is input to the liquid ejecting apparatus 1 (step S130), and when the control unit 2 determines that the image data Img is not input to the liquid ejecting apparatus 1 (N in step S130), the control unit 2 stands by for a period until the image data Img is input to the liquid ejecting apparatus 1. When the image data Img is not continuously input for a certain period, the control unit 2 may stop the supply of the power supply voltage to the various configurations of the liquid ejecting apparatus 1 and end the ejection determination method.

On the other hand, when the control unit 2 determines that the image data Img is input to the liquid ejecting apparatus 1 (Y in step S130), the liquid ejecting apparatus 1 shifts to a printing step including the printing process described above and forming an image corresponding to the image data Img on the medium P (step S140).

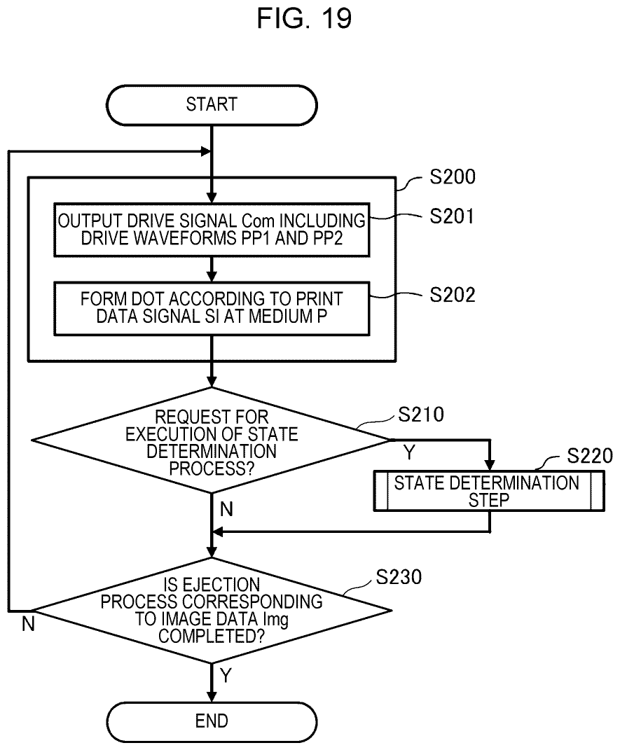

FIG. 19 is a diagram illustrating an example of the printing step. As illustrated in FIG. 19, in the printing step, the control unit 2 executes an ejection step including the ejection process described above (step S200). In the ejection step, the drive signal output unit 4 outputs the drive signal Com including the drive waveforms PP1 and PP2 (step S201). Specifically, in the ejection step, the control unit 2 outputs the drive waveform designation signal dCom corresponding to the drive waveforms PP1 and PP2 to the drive signal output unit 4, and the drive signal output unit 4 outputs the drive signal Com including the drive waveforms PP1 and PP2 by amplifying a signal waveform defined by the input drive waveform designation signal dCom.

In the ejection step, the control unit 2 generates the print data signal SI for controlling conduction states of the switches Wc[1] to Wc[M] respectively corresponding to the ejecting sections D[1] to D[M] in each of the control periods TQ1 and TQ2, and outputs the print data signal SI to the coupling state designation circuit 310. Therefore, the conduction states of the switches Wc[1] to Wc[M] are controlled in each of the control periods TQ1 and TQ2, and signal waveforms of the supply drive signals Vin[1] to Vin[M] respectively supplied to the ejecting sections D[1] to D[M] are controlled in each of the control periods TQ1 and TQ2. Therefore, in each of the control periods TQ1 and TQ2, the ink amount ejected from each of the ejecting sections D[1] to D[M] is defined, and a dot size to be formed on the medium P in each unit period TP is defined by the ink ejected from each of the ejecting sections D[1] to D[M]. That is, the dots according to the print data signal SI are formed on the medium P (step S202). Therefore, the ejection step is ended.

Thereafter, the control unit 2 determines whether or not a request for execution of a state determination process of determining a state of the ejecting section D[m] is generated (step S210). When the control unit 2 determines that the request for execution of the state determination process is generated (Y in step S210), the liquid ejecting apparatus 1 shifts to the state determination step including the state determination process described above (step S220), and determines the state of the ejecting section D that ejects the ink to the medium P. Details of the state determination step will be described below.

Here, the request for execution of the state determination process in step S210 may be generated, for example, at a time when the medium P on which an image is formed reaches between pages, or may be generated between ejection paths for ejecting inks to the medium P. In addition, a request of a user may be generated. That is, the state determination step including the state determination process may be executed between pages of the medium P on which the ink ejected from the plurality of ejecting sections D lands, or may be executed between the ejection paths. Here, the interval between the ejection path includes, for example, a time at which a moving direction of the carriage 110 is switched and the like.

When the control unit 2 determines that the request for the execution of the state determination process is not generated (N in step S210), or after the state determination step in step S220 is ended, the control unit 2 determines whether or not a formation process of an image corresponding to the image data Img on the medium P is completed. That is, the control unit 2 determines whether or not the ejection process corresponding to the image data Img is completed (step S230). Then, when the control unit 2 determines that the ejection process corresponding to the image data Img is not completed (N in step S230), the control unit 2 executes the ejection step including the ejection process in step S200 again. That is, the ejection step and the state determination step are repeatedly executed. On the other hand, when the control unit 2 determines that the ejection process corresponding to the image data Img is completed (Y in step S230), the printing step is ended, and the operation of the liquid ejecting apparatus 1 is in a state before the shift to the printing step.

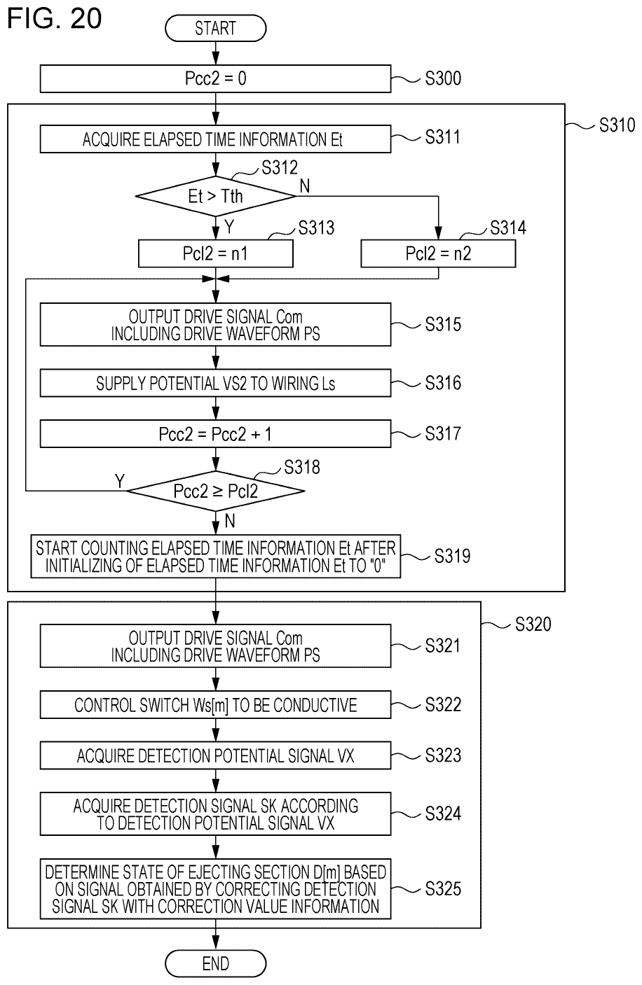

Next, the state determination step of shifting from step S120 and step S220 will be described. FIG. 20 is a diagram illustrating an example of the state determination step. As illustrated in FIG. 20, in the state determination step, the control unit 2 sets “0” to a charging count Pcc2 as an initial setting (step S300). After the initial setting is completed, a determination preparation step including the determination preparation process described above is executed (step S310).

In the determination preparation step, the control unit 2 acquires the elapsed time information Et (step S311). The elapsed time information Et corresponds to an elapsed time after the previous determination preparation step is executed. Here, when the liquid ejecting apparatus 1 first shifts to the state determination step after a power supply voltage is supplied to various configurations of the liquid ejecting apparatus 1, that is, shifts to the state determination step in step S120, the count of the elapsed time is not started, and thus, information on the elapsed time information Et is indefinite. In the present embodiment, when the liquid ejecting apparatus 1 first shifts to the state determination step after the power supply voltage is supplied to various configurations of the liquid ejecting apparatus 1, that is, shifts to the state determination step in step S120, the elapsed time information Et is set to the fixed value Etm in step S110. That is, in step S310 after the shift from step S120, the fixed value Etm is acquired as the elapsed time information Et.

The control unit 2 acquires the elapsed time information Et, and then determines whether or not the acquired elapsed time information Et is larger than a predetermined time threshold value Tth (step S312). Then, the control unit 2 sets “n1” as the charging count limit Pc12 when the elapsed time information Et is larger than the predetermined time threshold value Tth (Y in step S312) (step S313), and sets “n2” smaller than “n1” described above as the charging count limit Pc12 when the elapsed time information Et is not larger than the predetermined time threshold value Tth (N in step S312) (step S313). That is, the charging count limit Pc12 set when the elapsed time information Et is smaller than the time threshold value Tth is smaller than the charging count limit Pcl2 set when the elapsed time information Et is larger than the time threshold value Tth.

Thereafter, the drive signal output unit 4 outputs the drive signal Com including the drive waveform PS (step S315). Specifically, the control unit 2 generates the drive waveform designation signal dCom corresponding to the drive waveform PS and outputs the drive waveform designation signal dCom to the drive signal output unit 4, and the drive signal output unit 4 outputs the drive signal Com including the drive waveform PS by amplifying a signal waveform defined by the input drive waveform designation signal dCom. Here, as described above, the drive waveform PC is a signal waveform for driving the piezoelectric element PZ[m] such that an ink is not ejected from the ejecting section D[m] and predetermined residual vibration is generated when the drive waveform PC is input to the ejecting section D[m].

In addition, the control unit 2 generates the print data signal SI for controlling the switch Wf to be conductive in the control periods TT2 to TT4 in which a voltage value of the drive waveform PS is constant at the potential VS2, which is a voltage value of the drive signal Com output by the drive signal output unit 4, and outputs the print data signal SI to the coupling state designation circuit 310. Therefore, the coupling state designation circuit 310 controls the switch Wf to be conductive, in the control periods TT2 to TT4. As a result, in the control periods TT2 to TT4, the wiring Ls and the wiring Lc through which the drive signal Com propagates are electrically coupled to each other, and the potential VS2 is supplied to the wiring Ls (step S316).

Thereafter, the control unit 2 adds “1” to the charging count Pcc2 (step S317), and determines whether or not the charging count Pcc2 after the addition is equal to or larger than the charging count limit Pcl2 (step S318). When the control unit 2 determines that the charging count Pcc2 is not equal to or larger than the charging count limit Pc12 (N in step S318), the processes in steps S315 to S317 described above are executed again. That is, in the determination preparation step, the processes in step S315 to step S317 are repeatedly executed the number of times defined by the charging count limit Pcl2.

On the other hand, when the control unit 2 determines that the charging count Pcc2 is equal to or larger than the charging count limit Pcl2 (N in step S318), the control unit 2 initializes the elapsed time information Et to “0”, and then starts counting the elapsed time information Et (step S319), and ends the determination preparation step.

Here, the charging count limit Pcl2, which is the number of times the process in step S315 to step S317 is repeated, and which defines the number of times of the supply of the potential VS2 to the wiring Ls, is defined according to a time required for a voltage value of the wiring Ls to reach the potential VS2 by the process of supplying the potential VS2 to the wiring Ls in step S316. For example, when the maximum time required for the voltage value of the wiring Ls to reach the potential VS2 is 400 μs, and a time until the control periods TT2 to TT4 for supplying the potential VS2 to the wiring Ls is 40 μs, “n1” set to the charging count limit Pcl2 is set to “10”, and “n2” set to the charging count limit Pcl2 is set to a value smaller than “10”.

On the other hand, the time required for the voltage value of the wiring Ls to reach the potential VS2 also contributes to the voltage value of the wiring Ls immediately before the process of supplying the potential VS2 to the wiring Ls is started and immediately before the determination preparation step is executed. Specifically, the voltage value of the wiring Ls changes due to a leakage current generated in the wiring Ls. Therefore, the change amount in the voltage value of the wiring Ls is increased as an elapsed time after the previous determination preparation step is executed is increased. Then, when the change amount of the voltage value of the wiring Ls is large, the time required for the voltage value of the wiring Ls to reach the potential VS2 is large, and when the change amount of the voltage value of the wiring Ls is small, the time required for the voltage value of the wiring Ls to reach the potential VS2 is small.

In the liquid ejecting apparatus 1 of the present embodiment, when the elapsed time information Et is larger than the time threshold value Tth, that is, when an elapsed time after the previous determination preparation step is executed is large and the change amount of the voltage value of the wiring Ls is large, “n1” is set as the charging count limit Pcl2. When the elapsed time information Et is smaller than the time threshold value Tth, that is, when the elapsed time after the previous determination preparation step is executed is small and the change amount of the voltage value of the wiring Ls is small, “n2” smaller than “n1” described above as the charging count limit Pcl2 is set. Therefore, a time required for controlling the voltage value of the wiring Ls to the potential VS2 can be controlled according to the voltage value of the wiring Ls. Therefore, the time required to control the voltage value of the wiring Ls to the potential VS2 can be shortened, and the time required for the state determination step can be shortened.

That is, in the present embodiment, the determination preparation step of storing a charge in the capacitive component of the detection circuit 33 including the wiring Ls includes step S311 of acquiring the elapsed time information Et in accordance with the elapsed time after the previous determination preparation step is executed, steps S312, S313, and S314 of determining a charging time for storing a charge in the capacitive component of the detection circuit 33 including the wiring Ls in accordance with the acquired elapsed time information Et, and step S316 of storing a charge in the capacitive component of the detection circuit 33 including the wiring Ls by supplying the potential VS2 to the wiring Ls in accordance with the determined charging time. That is, the charging time for storing a charge in the capacitive component of the detection circuit 33 including the wiring Ls is determined according to the elapsed time after the charge is previously stored in the capacitive component of the detection circuit 33 including the wiring Ls.

At this time, the charging time when the elapsed time after the previous determination preparation step is executed is smaller than the predetermined time threshold value Tth is smaller than the charging time when the elapsed time after the previous determination preparation step is executed is larger than the predetermined time threshold value Tth. Therefore, the number of times of execution of the process in step S316 of storing a charge in the capacitive component of the detection circuit 33 including the wiring Ls by supplying the potential VS2 to the wiring Ls when the elapsed time after the previous determination preparation step is executed is smaller than the predetermined time threshold value Tth is set to be smaller than the number of times of execution of the process in step S316 of storing a charge in the capacitive component of the detection circuit 33 including the wiring Ls by supplying the potential VS2 to the wiring Ls when the elapsed time after the previous determination preparation step is executed is larger than the predetermined time threshold value Tth.

As a result, the time required to execute the determination preparation step can be shortened, and the time required for the state determination step can be shortened.

In the present embodiment, the number of times the process in step S316 of storing a charge in the capacitive component of the detection circuit 33 including the wiring Ls, which is a charging time determined in step S312, step S313, and step S314 of the determination preparation step first executed after the supply of the power supply voltage is started, is a constant value, specifically, is determined as “n1”, regardless of an elapsed time after the previous determination preparation step is executed in step S110 since the elapsed time information Et is set to the fixed value Etm.

In a period in which the supply of the power supply voltage is stopped, the amount of the leakage current generated in the wiring Ls is increased. As a result, the change amount in the voltage value of the wiring Ls increases, and in particular, when the supply circuit 31 is configured with one or a plurality of semiconductor devices, the amount of the leakage current generated in the wiring Ls is increased significantly, and as a result, the voltage value of the wiring Ls is changed significantly. In the present embodiment, in the determination preparation step that is first executed after the supply of the power supply voltage is started, the number of times of execution of the process in step S316 of storing a charge in the capacitive component of the detection circuit 33 including the wiring Ls is set to “n1”, which is a constant value, regardless of the elapsed time after the previous determination preparation step is executed. Therefore, the voltage value of the wiring Ls to the potential VS2 in the determination preparation step can be more reliably controlled. Therefore, accuracy of the detection potential signal VX propagating through the wiring Ls can be improved, and determination accuracy of the state of the ejecting section D[m] can be improved.

Then, the liquid ejecting apparatus 1 executes a determination step including the determination process described above after the determination preparation step is ended (step S320). That is, after the charge is stored in the capacitive component of the detection circuit 33 including the wiring Ls, the determination unit 8 determines the state of the ejecting section D[m] according to the detection signal SK output by the detection circuit 33. In other words, the charge is stored in the capacitive component of the detection circuit 33 including the wiring Ls before the determination unit 8 determines the state of the ejecting section D[m] according to the detection signal SK output by the detection circuit 33.

In the determination step, the drive signal output unit 4 outputs the drive signal Com including the drive waveform PS (step S321). Specifically, in the determination step, the control unit 2 outputs the drive waveform designation signal dCom corresponding to the drive waveform PS to the drive signal output unit 4, and the drive signal output unit 4 outputs the drive signal Com including the drive waveform PS by amplifying a signal waveform defined by the input drive waveform designation signal dCom.

In addition, in the determination step, the control unit 2 generates the print data signal SI for controlling the switch Wc[m] corresponding to the ejecting section D[m] as an inspection target to be conductive in the control periods TT1 and TT2 in which a voltage value of the drive signal Com output by the drive signal output unit 4, that is, a voltage value of the drive waveform PS starts at the reference potential V0 and changes to the potential VS1 having a potential lower than the reference potential V0, and then is at the potential VS2 having a potential higher than the reference potential V0 and maintains the potential VS2, and controlling the switch Ws[m] corresponding to the ejecting section D[m] as an inspection target to be conductive in the control periods TT2 to TT4 in which the voltage value of the drive waveform PS is at the potential VS2, and outputs the print data signal SI to the coupling state designation circuit 310. That is, the switch Ws[m] is controlled to be conductive (step S322). Therefore, a signal according to residual vibration generated in the ejecting section D[m] generated in the upper electrode Zu[m] of the piezoelectric element PZ[m] propagates through the wiring Ls as the detection potential signal VX and is input to the detection circuit 33.

Thereafter, the switch W1 is controlled to be non-conductive and the switch W2 is controlled to be conductive in the control period TT3 according to the print data signal SI output by the control unit 2. Thus, the detection circuit 33 acquires the detection potential signal VX corresponding to the residual vibration generated in the ejecting section D[m] (step S323), and outputs the detection signal SK according to the acquired detection potential signal VX to the determination unit 8. At this time, a noise component superimposed on the detection potential signal VX is removed.

The determination unit 8 acquires the detection signal SK according to the detection potential signal VX output by the detection circuit 33 (step S324), corrects the detection signal SK based on the acquired detection potential signal VX by using correction value information, calculates waveform information such as an amplitude, an amplitude attenuation factor, a period, and a frequency of the residual vibration generated in the ejecting section D[m] based on the corrected signal, and determines the state of the ejecting section D[m] as an inspection target according to the calculated waveform information. That is, the state of the ejecting section D[m] as an inspection target is determined based on a signal obtained by correcting the detection signal SK based on the detection potential signal VX with the correction value information (step S325).

In the state determination step, the states of the plurality of ejecting sections D may be determined. In this case, the steps in steps S321 to S324 are repeatedly executed for each of the plurality of ejecting sections D as an inspection target.

The determination step of determining the state of the ejecting section D[m] based on the correction value information and the detection signal SK based on the detection potential signal VX includes step S321 of supplying the drive waveform PS as the supply drive signal Vin[m] based on the drive signal Com to the piezoelectric element PZ[m], a step S322 of switching the switch Ws[m] such that the signal according to the residual vibration generated in the ejecting section D[m] propagates through the wiring Ls and is supplied to the detection circuit 33 as the detection potential signal VX after step S321, step S324 of acquiring the detection signal SK according to the detection potential signal VX output by the detection circuit 33 after step S322, and step S325 of determining the state of the ejecting section D[m] based on the signal obtained by correcting the detection signal SK acquired in step S324 with the correction value information.

Here, the ejecting sections D[1] to D[M] are examples of a plurality of ejecting sections, the detection circuit 33 including the wiring Ls is an example of a residual vibration detection circuit, and the determination unit 8 is an example of a determination circuit. In addition, the drive signal Com and the supply drive signal Vin based on the drive signal Com are examples of a drive signal, the drive waveform PS is an example of a drive waveform signal, a signal generated in the upper electrode Zu[m] of the piezoelectric element PZ[m] and the detection potential signal VX including the signal are examples of a residual vibration signal, the detection signal SK is an example of a residual vibration detection signal, and the time threshold value Tth is an example of a threshold time. In addition, the determination preparation step is an example of a pre-charging step, step S311 is an example of a time counting step, steps S312 to S314 are examples of a charging time determination step, and steps S315 to S316 are examples of a charging step. In addition, the determination step is an example of an ejection state determination step, step S321 is an example of a determination driving step, step S324 is an example of a residual vibration acquisition step, and step S325 is an example of an ejecting section determination step.

### 6. OPERATIONAL EFFECTS

In the ejection state determination method of the liquid ejecting apparatus 1 according to the present embodiment configured as described above, the acquisition step of acquiring the correction value information includes step S31 of supplying the drive waveform PC as the supply drive signal Vin[m] based on the drive signal Com to the piezoelectric element PZ[m], step S32 of switching the switch Ws[m] such that the signal according to the residual vibration generated in the ejecting section D[m] propagates through the wiring Ls and is supplied to the detection circuit 33 as the detection potential signal VX after step S31, step S34 of holding the detection signal SK according to the detection potential signal VX output by the detection circuit 33 after step S32 as the correction value information. The determination step of acquiring the correction value information based on the potential difference between both terminals of the switch Ws[m] is generated, that is, the differential pulse PLd generated according to the potential difference between the wiring Ls through which the detection potential signal VX output by the detection circuit 33 propagates and the piezoelectric element PZ[m] and determining the state of the ejecting section D[m] includes step S321 of supplying the drive waveform PS as the supply drive signal Vin[m] based on the drive signal Com to the piezoelectric element PZ[m], step S322 of switching the switch Ws[m] such that the signal according to the residual vibration generated in the ejecting section D[m] propagates through the wiring Ls and is supplied to the detection circuit 33 as the detection potential signal VX after step S321, step S324 of acquiring the detection signal SK according to the detection potential signal VX output by the detection circuit 33 after step S322, and step S325 of determining the state of the ejecting section D[m] based on the signal obtained by correcting the detection signal SK acquired in step S324 with the correction value information. In this case, even when the potential difference between both terminals of the switch Ws[m] is generated, that is, the potential difference between the wiring Ls through which the detection potential signal VX output by the detection circuit 33 propagates and the piezoelectric element PZ[m] is generated when determining the state of the ejecting section D[m], the possibility that the potential difference affects the determination accuracy of the ejection state from the ejecting section D[m] is reduced. Therefore, even when the voltage value of the wiring Ls through which the detection potential signal VX output by the detection circuit 33 propagates changes due to the leakage current or the like, and the potential difference is generated between the wiring Ls through which the detection potential signal VX output by the detection circuit 33 propagates and the piezoelectric element PZ[m], the determination accuracy of the ejection state of the ejecting section D[m] based on the residual vibration generated in the ejecting section D[m] can be improved.

In the liquid ejecting apparatus 1 according to the present embodiment, the acquisition preparation step of storing charges in the capacitive component of the detection circuit 33 including the wiring Ls is executed before the acquisition step is executed, and the determination preparation step of storing charges in the capacitive component of the detection circuit 33 including the wiring Ls is executed before the determination step is executed. Therefore, the potential difference between the wiring Ls through which the detection potential signal VX output by the detection circuit 33 propagates and the piezoelectric element PZ[m], which is the potential difference between the both terminals of the switch Ws[m] in the acquisition step and the determination step can be reduced. Therefore, the signal accuracy of the detection signal SK is improved, and the determination accuracy of the ejection state from the ejecting section D[m] based on the signal obtained by correcting the detection signal SK with the correction value information can be further improved.

In the ejection state determination method of the liquid ejecting apparatus 1 according to the present embodiment configured as described above, the determination preparation step of storing charges in the capacitive component of the detection circuit 33 including the wiring Ls includes step S311 of acquiring the elapsed time information Et in accordance with the elapsed time after the previous determination preparation step is executed, steps S312, S313, and S314 of determining the charging time for storing charges in the capacitive component of the detection circuit 33 including the wiring Ls in accordance with the acquired elapsed time information Et, and step S316 of storing charges in the capacitive component of the detection circuit 33 including the wiring Ls by supplying the potential VS2 to the wiring Ls in accordance with the determined charging time. Therefore, the time required for storing the charges in the capacitive component of the detection circuit 33 including the wiring Ls in accordance with the voltage value of the wiring Ls can be defined.

As a result, the time required to execute the determination preparation step can be shortened, and the time required for the state determination step can be shortened.

In the liquid ejecting apparatus 1 according to the present embodiment, the storage unit 9 stores, as the correction value information, the detection signal SK output by the detection circuit 33 in accordance with the detection potential signal VX including a signal output from the ejecting section D and propagating through the wiring Ls after the drive waveform PC as the supply drive signal Vin[m] based on the drive signal Com is supplied to the piezoelectric element PZ[m]. The determination unit 8 determines the state of the ejecting section D[m] based on the signal obtained by correcting the detection signal SK output by the detection circuit 33 in accordance with the detection potential signal VX including a signal output from the ejecting section D and propagating through the wiring Ls after the drive waveform PS as the supply drive signal Vin[m] based on the drive signal Com is supplied to the piezoelectric element PZ[m], with the correction value information stored in the storage unit 9. Therefore, the potential difference between the wiring Ls through which the detection potential signal VX output by the detection circuit 33 propagates and the piezoelectric element PZ[m], which is the potential difference between the both terminals of the switch Ws[m] can be reduced.

Therefore, the signal accuracy of the detection signal SK is improved, and the determination accuracy of the ejection state from the ejecting section D[m] based on the signal obtained by correcting the detection signal SK with the correction value information can be further improved.

In the liquid ejecting apparatus 1 according to the present embodiment, the charging time for storing the capacitive component of the detection circuit 33 including the wiring Ls with charges is determined according to the elapsed time after the capacitive component of the detection circuit 33 including the wiring Ls is previously stored with charges. Thus, the time required for the execution of the determination preparation step can be shortened, and the time required for the state determination step can be shortened.

### 7. MODIFICATION EXAMPLES

Here, in the present embodiment, the piezoelectric element PZ is described as being driven to eject the ink from the ejecting section D and outputting the signal according to the residual vibration generated in the ejecting section D. Meanwhile, the ejecting section D may have a configuration in which the piezoelectric element PZ as a driving element for ejecting an ink and the piezoelectric element PZ as a detection element for detecting residual vibration generated in the ejecting section D are individually included. In addition, at this time, the driving element for ejecting the ink in the ejecting section D is not limited to a piezoelectric element as long as the element can convert an electric signal into mechanical vibration, and the detection element for detecting the residual vibration generated in the ejecting section D is not limited to a piezoelectric element as long as the element can convert mechanical vibration into an electric signal.

In the present embodiment, the description is made on the assumption that the potential generated in the upper electrode Zu of the piezoelectric element PZ is output as a signal according to the residual vibration generated in the ejecting section D. Meanwhile, the potential generated in the lower electrode Zd of the piezoelectric element PZ may be output as a signal according to the residual vibration generated in the ejecting section D.

In addition, the signal according to the residual vibration generated in the ejecting section D may be a signal in which a current vibrates according to the residual vibration generated in the ejecting section D, or may be a signal in which a voltage vibrates according to the residual vibration generated in the ejecting section D. Therefore, the detection circuit 33 may be configured to detect a voltage value of the signal according to the residual vibration generated in the ejecting section D, or may be configured to detect a current value of the signal according to the residual vibration generated in the ejecting section D.

In addition, in the present embodiment, it is described that the signal waveform of the drive signal Com output by the drive signal output unit 4 is switched by the drive waveforms PP1 and PP2, the drive waveform PS, and the drive waveform PC, but the drive signal output unit 4 may individually include an amplifier circuit that outputs the drive waveforms PP1 and PP2, an amplifier circuit that outputs the drive waveform PS, and an amplifier circuit that outputs the drive waveform PC.

Hitherto, the embodiments and the modification examples are described. Meanwhile, the present disclosure is not limited to the embodiments, and can be implemented in various aspects within the scope not departing from the concept of the present disclosure. For example, the embodiments described above can also be appropriately combined with each other.

The present disclosure includes substantially the same configurations (for example, configurations having the same functions, methods, and results, or configurations having the same objects and effects) as the configurations described in the embodiments. Further, the present disclosure includes configurations in which non-essential parts of the configuration described in the embodiments are replaced. In addition, the present disclosure includes configurations that achieve the same operational effects or configurations that can achieve the same objects as those of the configurations described in the embodiments. Further, the present disclosure includes configurations in which a known technology is added to the configurations described in the embodiments.

The following contents are derived from the embodiments described above.

According to an aspect, there is provided an ejection state determination method by a liquid ejecting apparatus including a plurality of ejecting sections that eject a liquid by supplying of a drive signal, a residual vibration detection circuit that acquires any residual vibration signal, which is output by each of the plurality of ejecting sections, according to residual vibration generated after a driving element is driven and outputs a residual vibration detection signal according to the acquired residual vibration signal, and a determination circuit that determines a state of the ejecting section according to the residual vibration detection signal, the method including:
a pre-charging step of storing a charge in a capacitive component of the residual vibration detection circuit; and
an ejection state determination step of determining the state of the ejecting section based on the residual vibration detection signal, in which
the pre-charging step and the ejection state determination step are repeatedly executed,
the pre-charging step includes
   a time counting step of acquiring an elapsed time from a time when the previous pre-charging step is executed,
   a charging time determination step of determining a charging time for storing the charge in the capacitive component of the residual vibration detection circuit according to the elapsed time, and
   a charging step of storing the charge in the capacitive component of the residual vibration detection circuit according to the charging time, and
the ejection state determination step includes
   a determination driving step of supplying a drive waveform signal as the drive signal to the driving element,
   a residual vibration acquisition step of acquiring the residual vibration detection signal output by the residual vibration detection circuit after the determination driving step, and
   an ejecting section determination step of determining the state of the ejecting section based on the residual vibration detection signal acquired in the residual vibration acquisition step.

In the ejection state determination method, the pre-charging step of storing the charge in the capacitive component of the residual vibration detection circuit includes the time counting step of acquiring the elapsed time from the execution of the previous pre-charging step, the charging time determination step of determining the charging time for storing the charge in the capacitive component of the residual vibration detection circuit according to the elapsed time, and the charging step of storing the charge in the capacitive component of the residual vibration detection circuit according to the charging time. Therefore, the time for storing the charge in the capacitive component of the residual vibration detection circuit can be determined based on the elapsed time from the previous pre-charging step, that is, the amount of charge stored in the capacitive component of the residual vibration detection circuit. Therefore, when a sufficient charge is stored in the capacitive component of the residual vibration detection circuit, a time for storing the charge in the capacitive component of the residual vibration detection circuit can be shortened. That is, a time required for executing the ejection state determination method including the pre-charging step of storing the charge in the capacitive component of the residual vibration detection circuit at a detection speed of a signal corresponding to the residual vibration and the ejection state determination step of determining the state of the ejecting section based on the residual vibration detection signal can be reduced, without lowering determination accuracy of the state of the ejecting section.

In the ejection state determination method according to the aspect, the charging time when the elapsed time is shorter than a predetermined threshold time may be shorter than the charging time when the elapsed time is longer than the threshold time.

In the ejection state determination method, when a sufficient charge is stored in the capacitive component of the residual vibration detection circuit, the time for storing the charge in the capacitive component of the residual vibration detection circuit can be shortened, and the time required for executing the ejection state determination method can be shortened.

In the ejection state determination method according to the aspect, the number of charging times for storing the charge in the capacitive component of the residual vibration detection circuit in the charging step when the elapsed time is shorter than a predetermined threshold time may be smaller than the number of charging times for storing the charge in the capacitive component of the residual vibration detection circuit in the charging step when the elapsed time is longer than the threshold time.

In the ejection state determination method, when a sufficient charge is stored in the capacitive component of the residual vibration detection circuit, the time for storing the charge in the capacitive component of the residual vibration detection circuit can be shortened, and the time required for executing the ejection state determination method can be shortened.

In the ejection state determination method according to the aspect, the pre-charging step and the ejection state determination step may be executed between pages of a medium on which the liquid ejected from the plurality of ejecting sections lands.

In the ejection state determination method according to the aspect, the pre-charging step and the ejection state determination step may be executed between ejection paths.

In the ejection state determination method according to the aspect, in the charging time determination step included in the pre-charging step that is first executed after the supply of a power supply voltage is started, the charging time may be determined to have a constant value regardless of the elapsed time.

In a period in which the supply of the power supply voltage is stopped, a leakage current is increased, and the amount of decrease in charge in the capacitive component of the residual vibration detection circuit is increased. On the other hand, in this ejection state determination method, in the charging time determination step included in the pre-charging step that is first executed after the supply of the power supply voltage is started, the charging time is determined to have a constant value regardless of the elapsed time. Therefore, in the ejection state determination step, a sufficient charge can be stored in the charge in the capacitive component of the residual vibration detection circuit, and the possibility that the determination accuracy of the state of the ejecting section is lowered is reduced.

In the ejection state determination method according to the aspect, the ejecting section may include a piezoelectric element that outputs an electromotive force according to the residual vibration as the residual vibration signal.

In the ejection state determination method according to the aspect, the driving element may be a piezoelectric element, and the piezoelectric element may eject the amount of liquid according to displacement generated by supplying of the drive signal from the ejecting section.

According to another aspect, there is provided a liquid ejecting apparatus including:
a plurality of ejecting sections that eject a liquid by supplying of a drive signal;
a residual vibration detection circuit that acquires any residual vibration signal, which is output by each of the plurality of ejecting sections, according to residual vibration generated after a driving element is driven and outputs a residual vibration detection signal according to the acquired residual vibration signal; and
a determination circuit that determines a state of the ejecting section according to the residual vibration detection signal, in which
before the determination circuit determines the state of the ejecting section, a charging time for storing a charge in a capacitive component of the residual vibration detection circuit is determined according to an elapsed time from a time when the charge is previously stored in the capacitive component of the residual vibration detection circuit.

In this liquid ejecting apparatus, before the determination circuit determines the state of the ejecting section, the charging time for storing the charge in the capacitive component of the residual vibration detection circuit is determined according to the elapsed time after the charge is previously stored in the capacitive component of the residual vibration detection circuit. Therefore, when a sufficient charge is stored in the capacitive component of the residual vibration detection circuit, the time for storing the charge in the capacitive component of the residual vibration detection circuit can be shortened. Therefore, the time required for storing the charge in the capacitive component of the residual vibration detection circuit, which is a detection speed of a signal according to the residual vibration, can be reduced, without lowering the determination accuracy of the state of the ejecting section.

In the liquid ejecting apparatus according to the other aspect, the charging time when the elapsed time is shorter than a predetermined threshold time may be shorter than the charging time when the elapsed time is longer than the threshold time.

In this liquid ejecting apparatus, when a sufficient charge is stored in the capacitive component of the residual vibration detection circuit, a time for storing the charge in the capacitive component of the residual vibration detection circuit can be shortened.

In the liquid ejecting apparatus according to the other aspect, the number of charging times for storing the charge in the capacitive component of the residual vibration detection circuit when the elapsed time is shorter than a predetermined threshold time may be smaller than the number of charging times for storing the charge in the capacitive component of the residual vibration detection circuit when the elapsed time is longer than the threshold time.

In this liquid ejecting apparatus, when a sufficient charge is stored in the capacitive component of the residual vibration detection circuit, a time for storing the charge in the capacitive component of the residual vibration detection circuit can be shortened.

In the liquid ejecting apparatus according to the other aspect, the charge may be stored in the capacitive component of the residual vibration detection circuit between pages of a medium on which the liquid ejected from the plurality of ejecting sections lands, and then the determination circuit may determine the state of the ejecting section according to the residual vibration detection signal output by the residual vibration detection circuit.

In the liquid ejecting apparatus according to the other aspect, the charge may be stored in the capacitive component of the residual vibration detection circuit between ejection paths, and then the determination circuit may determine the state of the ejecting section according to the residual vibration detection signal output by the residual vibration detection circuit.

In the liquid ejecting apparatus according to the other aspect, the first charging time after the supply of a power supply voltage is started may be determined to have a constant value regardless of the elapsed time.

In a period in which the supply of the power supply voltage is stopped, a leakage current is increased, and the amount of decrease in charge in the capacitive component of the residual vibration detection circuit is increased. On the other hand, in this liquid ejecting apparatus, the charging time first determined after the supply of the power supply voltage is started is set to have a constant value regardless of the elapsed time, so that a sufficient charge can be stored in the capacitive component of the residual vibration detection circuit, and the possibility that the determination accuracy of the state of the ejecting section is lowered is reduced.

In the liquid ejecting apparatus according to the other aspect, the ejecting section may include a piezoelectric element that outputs an electromotive force according to the residual vibration as the residual vibration signal.

In the liquid ejecting apparatus according to the other aspect, the driving element may be a piezoelectric element, and the piezoelectric element may eject the amount of liquid according to displacement generated by supplying of the drive signal from the ejecting section.

What is claimed is:

1. An ejection state determination method by a liquid ejecting apparatus including a plurality of ejecting sections that eject a liquid by supplying of a drive signal, a residual vibration detection circuit that acquires any residual vibration signal, which is output by each of the plurality of ejecting sections, according to residual vibration generated after a driving element is driven and outputs a residual vibration detection signal according to the acquired residual vibration signal, and a determination circuit that determines a state of the ejecting section according to the residual vibration detection signal, the method comprising:
a pre-charging step of storing a charge in a capacitive component of the residual vibration detection circuit; and
an ejection state determination step of determining the state of the ejecting section based on the residual vibration detection signal, wherein
the pre-charging step and the ejection state determination step are repeatedly executed,
the pre-charging step includes
a time counting step of acquiring an elapsed time from a time when the previous pre-charging step is executed,
a charging time determination step of determining a charging time for storing the charge in the capacitive component of the residual vibration detection circuit according to the elapsed time, and
a charging step of storing the charge in the capacitive component of the residual vibration detection circuit according to the charging time, and
the ejection state determination step includes
a determination driving step of supplying a drive waveform signal as the drive signal to the driving element,
a residual vibration acquisition step of acquiring the residual vibration detection signal output by the residual vibration detection circuit after the determination driving step, and
an ejecting section determination step of determining the state of the ejecting section based on the residual vibration detection signal acquired in the residual vibration acquisition step.

2. The ejection state determination method according to claim 1, wherein
the charging time when the elapsed time is shorter than a predetermined threshold time is shorter than the charging time when the elapsed time is longer than the threshold time.

3. The ejection state determination method according to claim 1, wherein
the number of charging times for storing the charge in the capacitive component of the residual vibration detection circuit in the charging step when the elapsed time is shorter than a predetermined threshold time is smaller than the number of charging times for storing the charge in the capacitive component of the residual vibration detection circuit in the charging step when the elapsed time is longer than the threshold time.

4. The ejection state determination method according to claim 1, wherein
the pre-charging step and the ejection state determination step are executed between pages of a medium on which the liquid ejected from the plurality of ejecting sections lands.

5. The ejection state determination method according to claim 1, wherein
the pre-charging step and the ejection state determination step are executed between ejection paths.

6. The ejection state determination method according to claim 1, wherein
in the charging time determination step included in the pre-charging step that is first executed after the supply of a power supply voltage is started, the charging time is determined to have a constant value regardless of the elapsed time.

7. The ejection state determination method according to claim 1, wherein
the ejecting section includes a piezoelectric element that outputs an electromotive force according to the residual vibration as the residual vibration signal.

8. The ejection state determination method according to claim 1, wherein
the driving element is a piezoelectric element, and the piezoelectric element ejects the amount of liquid according to displacement generated by supplying of the drive signal from the ejecting section.

9. A liquid ejecting apparatus comprising:
a plurality of ejecting sections that eject a liquid by supplying of a drive signal;
a residual vibration detection circuit that acquires any residual vibration signal, which is output by each of the plurality of ejecting sections, according to residual vibration generated after a driving element is driven and outputs a residual vibration detection signal according to the acquired residual vibration signal; and
a determination circuit that determines a state of the ejecting section according to the residual vibration detection signal, wherein
before the determination circuit determines the state of the ejecting section, a charging time for storing a charge in a capacitive component of the residual vibration detection circuit is determined according to an elapsed time from a time when the charge is previously stored in the capacitive component of the residual vibration detection circuit.

10. The liquid ejecting apparatus according to claim 9, wherein
the charging time when the elapsed time is shorter than a predetermined threshold time is shorter than the charging time when the elapsed time is longer than the threshold time.

11. The liquid ejecting apparatus according to claim 9, wherein
the number of charging times for storing the charge in the capacitive component of the residual vibration detection circuit when the elapsed time is shorter than a predetermined threshold time is smaller than the number of charging times for storing the charge in the capacitive component of the residual vibration detection circuit when the elapsed time is longer than the threshold time.

12. The liquid ejecting apparatus according to claim 9, wherein
the charge is stored in the capacitive component of the residual vibration detection circuit between pages of a medium on which the liquid ejected from the plurality of ejecting sections lands, and then the determination circuit determines the state of the ejecting section according to the residual vibration detection signal output by the residual vibration detection circuit.

13. The liquid ejecting apparatus according to claim 9, wherein
the charge is stored in the capacitive component of the residual vibration detection circuit between ejection paths, and then the determination circuit determines the state of the ejecting section according to the residual vibration detection signal output by the residual vibration detection circuit.

14. The liquid ejecting apparatus according to claim 9, wherein
the first charging time after the supply of a power supply voltage is started is determined to have a constant value regardless of the elapsed time.

15. The liquid ejecting apparatus according to claim 9, wherein
the ejecting section includes a piezoelectric element that outputs an electromotive force according to the residual vibration as the residual vibration signal.

16. The liquid ejecting apparatus according to claim 9, wherein
the driving element is a piezoelectric element, and the piezoelectric element ejects the amount of liquid according to displacement generated by supplying of the drive signal from the ejecting section.
